(19) United States
(12) Patent Application Publication
(10) Pub. No.: US 2023/0027017 A1
(43) Pub. Date: Jan. 26, 2023

(54) Porous Composite Membrane for Solvent Extraction

(71) Applicant: New Jersey Institute of Technology, Newark, NJ (US)

(72) Inventors: Kamalesh Sirkar, Bridgewater, NJ (US); Lydia Rodrigues, Linden, NJ (US)

(73) Assignee: New Jersey Institute of Technology, Newark, NJ (US)

(21) Appl. No.: 17/857,580

(22) Filed: Jul. 5, 2022

Related U.S. Application Data
(60) Provisional application No. 63/218,674, filed on Jul. 6, 2021.

(51) Int. Cl. B01D 61/24; B01D 69/12; B01D 69/08; B01D 69/06; B01D 69/02; B01D 71/34; B01D 71/36; B01D 71/26; B01D 71/56; B01D 71/52; B01D 67/00; B01D 11/04

(52) U.S. Cl. CPC B01D 61/246; B01D 69/12; B01D 69/08; B01D 69/06; B01D 69/02; B01D 71/34; B01D 71/36; B01D 71/262; B01D 71/56; B01D 71/5222; B01D 67/0088; B01D 69/1218; B01D 11/0415; B01D 2325/36; B01D 2325/38; B01D 2325/022; B01D 2323/02; B01D 2323/04

(57) ABSTRACT

An example porous composite membrane for solvent extraction is provided. The porous composite membrane includes a Janus membrane with a first side and a second side opposing the first side. The first side exhibits hydrophobic characteristics and the second side exhibits hydrophilic characteristics. At least one of the first side or the second side is sized to perform nondispersive membrane solvent extraction.

### CROSS-REFERENCE TO RELATED APPLICATIONS

This application claims the benefit of co-pending U.S. Provisional Patent Application No. 63/218,674, which was filed on Jul. 6, 2021. The entire content of the foregoing provisional patent application is incorporated herein by reference.

### STATEMENT OF GOVERNMENT SUPPORT

This invention was made with government support under Agreement Nos. 1034710 and 1822130 awarded by the National Science Foundation. The government has certain rights in the invention.

### FIELD OF THE DISCLOSURE

The present disclosure relates to solvent extraction. In particular, the present disclosure relates to a porous composite membrane (such as a Janus membrane, or the like) for nondispersive membrane solvent extraction.

### BACKGROUND

Solvent extraction is usually carried out in small or large scale by dispersing one phase as drops in the other phase; after extraction, the phases are separated in a separating funnel in laboratories or in mixer-settlers/tall columns in industrial operations. Dispersive industrial extraction operations dependent on phase density difference may be problematic due to flooding, loading, and low values of allowable phase flow rate ratios. Further, dispersion generally requires energy, and coalescence is problematic especially if emulsion formation takes place.

To bypass such problems, nondispersive solvent extraction via a porous hydrophobic membrane was developed such that the organic phase flowing on one side of the membrane wets the membrane pores, and the aqueous phase flowing on the other side and not wetting the pores is maintained at the same or at a higher pressure. (See, e.g., Kiani, A. et al., Solvent Extraction with Immobilized Interfaces in a Microporous Hydrophobic Membrane, J. Membrane Sci., 20, 125-145 (1984)). The aqueous-organic phase interface is immobilized at the membrane pore mouth on the aqueous side; unless the excess aqueous phase pressure exceeds that of the organic by a critical value, ΔP_{crit}, the aqueous-organic interface is stable. Solute/s can be extracted from one phase to the other through this interface without any phase dispersion. This hydrophobic membrane process has been studied and well characterized for flat membranes and especially porous hydrophobic hollow fiber membranes. (See, e.g., Frank, G. T. et al., Alcohol Production by Yeast Fermentation and Membrane Extraction, Biotechnology and Bioengineering Symp. Series, 15, 621-631 (1985); Prasad, R. et al., Further Studies on Solvent Extraction with Immobilized Interfaces in a Microporous Hydrophobic Membrane, J. Membrane Sci., 26 (1), 79-97 (1986); D′Elia, N. A. et al., Liquid-liquid Extractions with Microporous Hollow Fibers. J. Membrane Sci., 29, 309 (1986); Prasad, R. et al., Dispersion-free Solvent Extraction with Microporous Hollow Fibers, AIChE J., 34, 177-188 (1988)). There are numerous applications in two-phase systems, large-scale devices, and commercial applications (see, e.g., Dahuron, L. et al., Protein Extraction with Hollow Fibers, AIChE J. 34(1), 130 (1988); Reed, B. W. et al., “Membrane Contactors”, Chapter 10, in Membrane Separations Technology: Principles and Applications, R.D. Noble and S.A. Stern (Eds.), Elsevier, New York (1995); Pabby, A. K. et al., Developments in Non-dispersive Membrane Extraction-Separation Processes, Chap. 8, in “Ion Exchange and Solvent Extraction”, Y. Marcus and A. K. Sengupta (Eds.), Marcel Dekker (2002), Vol. 15, pp. 331-350; Schlosser, S. et al., Recovery and Separation of Organic Acids by Membrane-based Solvent Extraction and Pertraction: An Overview with a Case Study on Recovery of MPCA. Sep. Purif. Technol., 41, 237 (2005); Sirkar, K. K., Membranes, Phase Interfaces and Separations: Novel Techniques and Membranes-An Overview, I&E Chem. Res., 47, 5250-5266 (2008). (100th Anniversary Review); Alguacil, F. J. et al., Dispersion-Free Solvent Extraction of Cr (VI) from Acidic Solutions Using Hollow Fiber Contactor. Environ. Sci. Technol., 2009, 4, 7718-7722; Grzenia, D. L. et al., Conditioning biomass hydrolysates by membrane extraction, J. of Membrane Sci., 415, 75-84 (2012)), as well as in analytical chemistry (see, e.g., Jonsson, J. A. et al., Membrane extraction in analytical chemistry, J. of Separation Sci., 24 (7), 495-626 (2001)). Reviews of membrane solvent extraction (MSX) technique are also available. (See, e.g., Song, J. et al., A critical review on membrane extraction with improved stability: Potential application for recycling metals from city mine, Desalination, 440, 18-38 (2018); Riedl, W., Membrane-supported liquid-liquid extraction-where do we stand today, ChemBioEng Rev., 8, No. 1,6-14 (2021)).

Such a concept can work with a porous hydrophilic membrane as well: aqueous phase flowing on one side preferentially wets the hydrophilic membrane pores and organic phase flowing on the other side is maintained at a higher pressure below a critical value, ΔP_{crit}. (See, e.g., Prasad, R. et al., Solvent Extraction with Microporous Hydrophilic and Composite Membranes. AIChE J., 33, 1057-1066 (1987)). Nondispersive hydrophilic membrane solvent extraction (MSX) devices have also been scaled up. (See, e.g., Sirkar, K. K., Membranes, Phase Interfaces and Separations: Novel Techniques and Membranes-An Overview, I&E Chem. Res., 47, 5250-5266 (2008). (100th Anniversary Review); Lopez, J. L. et al., A multi-phase/extractive enzyme membrane reactor for production of diltiazem chiral intermediate, J. Membrane Sci., 125, 189-211 (1997)).

Use of a porous hydrophobic or porous hydrophilic membrane for MSX encounters, however, an operational problem. Countercurrent flow is used for high solute recovery in solvent extraction. Inevitably, there is a significant pressure drop in the liquid phase flowing on each side of the membrane, which may lead to or exceed maximum allowable phase pressure difference at both ends of the narrow flow channels. This can lead to a phase breakthrough if ΔP between the two liquid phases exceeds ΔP_{crit} for the system. It is known that ΔP_{crit} is ∝(γ/dₚ) where y is the interfacial tension and dₚ is the membrane pore diameter. (See, e.g., Kim, B. S. et al., Critical Entry Pressure for Liquids in Hydrophobic Membranes, J. Colloid Interf. Sci., 115, (1), 1 (1987)). Lowering dₚ leads to a higher ΔP_{crit} but, it can also lead to a higher diffusional resistance through the membrane. Systems with low γ pose operational problems.

A concept was demonstrated with a porous hydrophobic membrane placed on top of a porous hydrophilic membrane. (See, e.g., Prasad, R. et al., Solvent Extraction with Microporous Hydrophilic and Composite Membranes. AIChE J., 33, 1057-1066 (1987)). The organic phase flowing on the hydrophobic membrane side wetted its respective pores, while the aqueous phase flowing on the hydrophilic membrane side wetted its respective pores. See id. This configuration allowed either liquid-phase to flow at a pressure higher than that of the other phase pressure, allowing considerable flexibility of operation compared to that with a membrane having a single wetting property. However, this concept has two shortcomings. First, use of two membranes increases the diffusion distance and reduces mass flux, as compared to use of a single membrane. In cases where the solute partition coefficient highly favors a particular phase, addition of a second membrane whose pores are wetted by that phase will not unduly increase the mass transport resistance. Second, both liquids can flow into any space between the stacked membranes. If the membranes are not adhered together or supported on a short enough scale, fluid can collect between the membranes and further increases the solute diffusion distance during solvent extraction.

As such, a need exists for a single membrane that solves to reduce or eliminate the pressure limitation that affects nondispersive MSX. The exemplary porous composite membrane of the present disclosure addresses these needs.

### SUMMARY

In accordance with embodiments of the present disclosure, exemplary embodiments are directed to a single membrane, which exhibits hydrophobic characteristics on one side and hydrophilic characteristics on the other side. Such a membrane having a hydrophobic-hydrophilic characteristic is a Janus membrane with asymmetric wettability. The immobilized aqueous-organic phase interface disclosed herein is inside the membrane, where the physical boundary of the hydrophobic-hydrophilic characteristics of the polymers is located.

In one embodiment, the Janus membrane can be fabricated by a coating of a hydrophilic layer on top of a hydrophobic, superhydrophobic, or omniphobic base membrane. In one embodiment, the Janus membrane can be a multilayer hydrophilic and superhydrophobic membrane. In another embodiment, the Janus membrane can be a hydrophilic and omniphobic membrane. In another embodiment, the Janus membrane can be a two-faced membrane, with both sides of the membrane having different wetting properties. Janus membranes have been studied for a few applications, e.g., direct contact membrane distillation (DCMD), emulsion breaking, and liquid/fog collection. Studies in DCMD include: composite membranes prepared with fluorinated hydrophobic surface modifying macromolecules during hydrophilic membrane casting (see, e.g., Khayet, M. et al., Porous hydrophobic/hydrophilic composite membranes Application in desalination using direct contact membrane distillation, J. Membrane Sci., 252, 101-113 (2005); Khayet, M. et al., Design of novel direct contact membrane distillation membranes, Desalination, 192(1-3), 105-111 (2006); Khayet, M. et al., Porous hydrophobic/hydrophilic composite membranes preparation and application in DCMD desalination at higher temperatures, Desalination, vol. 199, no. 1-3, pp. 180-181, (2006)); dual layer hollow fiber spinning with an outer hydrophobic PVDF layer and an inner PAN-PVDF filled with high thermal conductivity additives (see, e.g., Su, M. et al., Effect of inner-layer thermal conductivity on flux enhancement of dual-layer hollow fiber membranes in direct contact membrane distillation, J. Membrane Sci., 364(1), 278-289 (2010)); plasma surface modification of hydrophilic flat and hollow fiber membranes of polyethersulfone (PES) (see, e.g., Wei, X. et al., CF₄ plasma surface modification of asymmetric hydrophilic polyethersulfone membranes for direct contact membrane distillation, J. Membrane Sci., 407-408, 164-175 (2012); Eykens, L. et al., Coating techniques for membrane distillation: An experimental assessment, Sep. and Purif. Technol., 193, 38-48, (2018); Sharma, A. K. et al., Sirkar, Porous hydrophobic-hydrophilic composite hollow fiber and flat membranes prepared by plasma polymerization for direct contact membrane distillation, Membranes, 11, 120 (2021)), and flat PVDF membranes (see, e.g., Puranik, A. A. et al., Porous hydrophobic-hydrophilic composite membranes for direct contact membrane distillation, J. Membrane Sci., 591,117225 (2019)); and a dual-layer membrane with a thin hydrophobic PVDF top-layer and a thick hydrophilic PVDF-polyvinyl alcohol sub-layer prepared by non-solvent thermally induced phase separation (see, e.g., Liu, Y. et al., Fabrication of novel Janus membrane by non-solvent thermally induced phase separation (NTIPS) for enhanced performance in membrane distillation, J. Membrane Sci., 563, 298-308 (2018)). The requirements for effective DCMD membranes are: high liquid entry pressure (LEP); high water vapor permeability; low thermal conductivity. (See, e.g., Khayet, M. et al., Porous hydrophobic/hydrophilic composite membranes Application in desalination using direct contact membrane distillation, J. Membrane Sci., 252, 101-113 (2005)).

There are several differences between membrane solvent extraction and membrane distillation. In membrane distillation, with or without using a Janus membrane, the two liquids on two sides of the porous membrane can never contact each other at any surface inside or on outside surfaces of the membrane. Instead, the two liquid surfaces are separated by an air gap. Vapor generated from the hot liquid diffuses through the air gap inside the membrane pores due to hydrophobic surface and condenses in the cold liquid on the other interface created by the cold liquid. If this does not occur, the membrane distillation process stops. This operation is therefore essential for membrane distillation such that vapor from one liquid passes through an air-filled pore and condenses in the other liquid on the other end of the pore.

In membrane solvent extraction employing a regular porous hydrophobic or hydrophilic membrane, the two liquids on two sides of the membrane are in contact with each other at one surface of the membrane. There is no air gap and there is no vapor phase. The two liquid phases are immiscible. Solutes are extracted from one phase into another phase via solvent extraction. Using a Janus membrane, the two immiscible liquid phases are in contact with each other somewhere inside of the membrane where the hydrophobic surface ends and the hydrophilic surface begins.

In membrane distillation, a vapor generated from the hot liquid side is transferred to the cold liquid on the other side of the membrane through the air gap inside the membrane. It is one way transfer from the hot liquid to the cold liquid. In membrane solvent extraction employing conventional hydrophobic or hydrophilic, or a Janus membrane, solutes can be extracted from either phase into the other phase. It is based on the principle of partitioning between two immiscible phases; no vapor is generated at all. Solute extraction can therefore take place in either direction.

One of the most common examples of membrane distillation involves desalination of water. If a porous hydrophilic membrane was used, membrane distillation of saline water would not work since the membrane pores would be wetted by saline water and saline water pass through to the distillate side. Membrane solvent extraction works due to a hydrophilic membrane. In addition, Janus membranes for solvent extraction have a high solvent resistance, while there is no such requirement in membrane distillation.

Successful MSX requirements are quite different: high phase breakthrough pressure, high solute mass transfer rate in extraction, and high chemical, solvent, and pH resistances, among others. Further, the membrane should be capable of carrying out nondispersive MSX from either side of the membrane, unlike that in DCMD. Janus membranes have been studied for breaking oil-in-water and water-in-oil emulsions with cotton fabric filter (see, e.g., Wang, Z. et al., Rapid and Efficient Separation of Oil from Oil-in-Water Emulsions Using a Janus Cotton Fabric, Angew. Chem. Int. Ed., 55, 1291 —1294 (2016)), flat membranes (see, e.g., Wu, M. B. et al., Janus Membranes with Opposing Surface Wettability Enabling Oil-to-Water and Water-to-Oil Emulsification. ACS Appl. Mater. Interfaces, 9, 5062-5066 (2017); Li, T. et al., Janus Polyvinylidene Fluoride Membrane with Extremely Opposite Wetting Surfaces via One Single-Step Unidirectional Segregation Strategy, ACS Appl. Mater. Interfaces, 10, 24947-24954 (2018)), and hollow fibers (see, e.g., Li, H. N. et al., Hollow fiber membranes with Janus surfaces for continuous demulsification and separation of oil-in-water emulsions, J. Membrane Sci., 602, 117964 (2020)). The function of such membranes, the mechanism of separation, the demands on the membrane by the specific systems under consideration and their use configurations are very different from those in membrane solvent extraction.

In accordance with embodiments of the present disclosure, an exemplary porous composite membrane for solvent extraction is provided. The porous composite membrane includes a single membrane comprising a first side and a second side opposing the first side. The first side exhibits hydrophobic characteristics and the second side exhibits hydrophilic characteristics. In some embodiments, either the first side or the second side is sized to perform nondispersive membrane solvent extraction. In some embodiments, at least one of the first side or the second side is sized to perform nondispersive membrane solvent extraction. In some embodiments, both the first side or the second side is sized to perform nondispersive membrane solvent extraction.

In some embodiments, the single membrane can be a Janus flat membrane. In some embodiments, the single membrane can be a Janus hollow fiber membrane. In some embodiments, the first side can be uncoated and the second side can be coated with a hydrophilic coating. In some embodiments, the first side can be coated with a hydrophobic coating and the second side can be uncoated.

The single membrane can include pores extending through the single membrane from at least one of (i) the first side to the second side, or (ii) the second side to the first side. During nondispersive membrane solvent extraction, the single membrane is configured to receive a first phase along the first side and within the pores of the first side, and a second phase along the second side and the pores of the second side. The first phase can be an organic phase and the second phase can be an aqueous phase.

In some embodiments, a pressure of the first phase within the pores exceeds a pressure of the second phase along the second side without creating phase dispersion through the single membrane. Even if a breakthrough pressure of the first and second phases is exceeded, phase dispersion through the single membrane is prevented by at least one of the hydrophilic characteristics of the second side or the hydrophobic characteristics of the first side. In some embodiments, a pressure of the second phase within the pores exceeds a pressure of the first phase along the first side without creating phase dispersion through the single membrane. In some embodiments, the single membrane is formed from polypropylene (PP), polyvinylidene fluoride (PVDF), polyamide (Nylon) membrane, polyetheretherketone (PEEK), ethylene chlorotrifluoroethylene (ECTFE), or polytetrafluoroethylene (PTFE).

In accordance with embodiments of the present disclosure, an exemplary method for nondispersive membrane solvent extraction is provided. The method includes providing a single membrane including a first side and a second side opposing the first side. The first and second sides have asymmetric wettability. The method includes passing a first phase along the first side of the single membrane. The method includes passing a second phase along the second side of the single membrane. In some embodiments, either the first side or the second side is sized to perform nondispersive membrane solvent extraction. In some embodiments, at least one of the first side or the second side is sized to perform nondispersive membrane solvent extraction. In some embodiments, both the first side or the second side is sized to perform nondispersive membrane solvent extraction.

In some embodiments, the single membrane can be a Janus flat membrane. In some embodiments, the single membrane can be a Janus hollow fiber membrane. The first side exhibits hydrophobic characteristics and the second side exhibits hydrophilic characteristics. The single membrane includes pores extending through the single membrane from at least one of (i) the first side to the second side, or (ii) the second side to the first side.

The membrane is configured to receive the first phase within the pores of the first side of the single membrane, and the second phase along the second side and the pores of the second side. The first phase can be an organic phase and the second phase can be an aqueous phase.

The method can include preventing phase dispersion through the single membrane even if a pressure of the first phase within the pores exceeds a pressure of the second phase along the second side. The method can include preventing phase dispersion through the single membrane even if a pressure of the second phase within the pores exceeds a pressure of the first phase along the first side.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed porous composite membrane for solvent extraction and associated systems and methods, reference is made to the accompanying figures, wherein:

FIGS. 1A and 1B show a comparison between nondispersive solvent extraction pressure constraints in traditional hydrophobic membranes (FIG. 1A) and an exemplary porous composite membrane (i.e., a Janus membranes with a coating) (FIG. 1B);

FIG. 2 shows a concentration profile of solute being transferred from one phase to the other in MSX for an exemplary porous composite membrane (i.e., a composite hydrophobic-hydrophilic membrane, a Janus membrane);

FIG. 3 is a graphical depiction showing the effect of Q_{aq} and ΔP on Kₒ for octanol/phenol/water system of a hydrophobic PP membrane hydrophilized on one side (AKS-7048) and a pristine hydrophobic PP membrane: Q_{org}=1.8 ml/min;

FIG. 4 is a graphical depiction showing the effect of Q_{aq} and Q_{org} on Kₒ for octanol/phenol/water system of a hydrophilic nylon membrane hydrophobized on one side (AKS-7050): Q_{org}=1.8 ml/min, ΔP=1.6 psi, excess pressure on the aqueous side;

FIG. 5 is a graphical depiction showing the effect of phase pressure on overall solute mass transfer coefficient in MSX for octanol/phenol/water system using a hydrophobic PP membrane hydrophilized on one side (AKS-7048) and a hydrophilic Nylon membrane hydrophobized on one side (AKS 7050): Q_{org}=1.3 ml/min, Q_{aq}=2.1 ml/min. Negative AP (in psi) corresponds to an excess pressure on the organic side while positive AP (in psi) corresponds to an excess pressure on the aqueous side;

FIGS. 6A, 6B, 6C and 6D illustrate SEM micrographs of flat PP membranes, including a PP original surface (FIG. 6A), a PP AKS 7048 coated surface (FIG. 6B), a PP original cross section (FIG. 6C), and a PP AKS 7048 cross section showing coated surface (FIG. 6D);

FIG. 7 is a graphical depiction showing the MSX for toluene/acetone/water system using a hydrophobic PP membrane treated on one side via plasma polymerization (AKS-7048): ΔP≈5 psi (excess org. pressure); For Q_{aq} variation, Q_{org}=1.8 ml/min. For Q_{org} variation, Q_{aq}=1.1 ml/min;

FIG. 8 is a graphical depiction showing the FTIR spectrum for PVDF membrane samples; Sample A: original PVDF-VVHP (hydrophobic); Sample B, C and D: PVDF treated with KOH for 3, 4, and 5 days, respectively, followed by an AA solution;

FIG. 9 is a graphical depiction showing the effect of Q_{aq} for toluene/acetone/water system of a pristine hydrophobic PVDF membrane and a hydrophobic PVDF membrane treated with KOH and an acrylic acid soln.: Q_{org}=1.8 ml/min. ΔP=10 psi (excess org. pressure) and 10 psi (excess aq. pressure) for the 5M KOH treated and original membrane, respectively;

FIG. 10 is a graphical depiction showing the effect of Q_{org} for toluene/acetone/water system of a pristine hydrophobic PVDF membrane and a hydrophobic PVDF membrane treated with KOH and an acrylic acid soln.: Q_{aq}=1.1 ml/min. ΔP=10 psi (excess org. pressure) and 10 psi (excess aq. pressure) for the 5M KOH treated and original membrane, respectively;

FIG. 11 is a graphical depiction showing the effect of phase pressure on overall solute mass transfer coefficient in MSX for toluene/acetone/water system using a hydrophilic PVDF membrane hydrophobized on one side (AKS-6943 A-4): Q_{org}=1.8 ml/min, Q_{aq}=2.1 ml/min; negative AP (in psi) corresponds to an excess pressure on the organic side while positive AP (in psi) corresponds to an excess pressure on the aqueous side;

FIG. 12 is a graphical depiction showing the effect of Q_{aq} and Q_{org} on K₀ for octanol/phenol/water system of a PVDF membrane in which 50% of depth is hydrophobic and 50% hydrophilic: Q_{org}=1.8 ml/min for Q_{aq} variation, Q_{aq}=1.1 for Q_{org} variation, ΔP≈2 psi, excess pressure on the organic side;

FIG. 13 is a diagrammatic view of an experimental set-up for measuring LEP of a membrane;

FIG. 14 is a diagrammatic view of an experimental set-up of droplet breakthrough pressure test: N2=Compressed nitrogen; PG=Pressure gauge; R-org=Solvent feed reservoir; R-aq=Aqueous feed reservoir; V=Needle valve;

FIG. 15 is a diagrammatic view of a flat membrane test cell for MSX (not drawn to scale);

FIG. 16 is a diagrammatic view of a membrane solvent extraction set-up;

FIG. 17 is a graphical depiction showing a UV-Vis calibration curve for phenol concentration in octanol measured at 273.0 nm;

FIG. 18 is a graphical depiction showing a GC calibration curve for acetone concentration in toluene;

FIG. 19 is a graphical depiction showing a GC calibration curve for acetone concentration in water/ethanol;

FIG. 20 shows a pore size reduction during coating of a hydrophilic substrate with a hydrophobic plasma polymerized coating leads to higher LEP value from the coated side;

FIG. 21 is a FTIR spectrum for PP membrane samples; Sample A: original PP membrane; Sample B: PP-AKS 7048 treated side;

FIG. 22 is a graphical depiction showing the effect of phase pressure on K. for octanol/phenol/water system of a hydrophobic PEEK membrane with plasma polymerized hydrophilic coating: Q_{orq}=1.8 ml/min, Q_{aq}=1.1; Negative ΔP (in psi) corresponds to an excess pressure on the organic side while positive ΔP (in psi) corresponds to an excess pressure on the aqueous side;

FIG. 23 shows a concentration profile of solute being transferred from one phase to the other in MSC for an exemplary porous composite membrane, and a graphical depiction showing the effect of phase pressure on overall solute mass transfer coefficient in MSC for octonal/phenol/water system using a hydrophobic PP membrane hydrophilized on one side and a hydrophilic Nylon membrane hydrophobized on one side;

FIG. 24 shows a hollow fiber module of 8″long hydrophobic PVDF fibers with OD hydrophilized;

FIGS. 25A, 25B and 25C are photographs of hydrophilized Arkema-PVDF hollow fibers using KOH treatment for five (5) days followed by an acrylic acid treatment: FIGS. 25A and 25B illustrate ends of the hollow fibers with the treated side on the outside turned brown and the inside (non-treated side) retaining the original white color, and FIG. 25C illustrates a view looking down on the treated hollow fibers; and

FIG. 26 is a graphical depiction showing membrane solvent extraction results (Kₒ vs. Q_{org} and Q_{aq}) for PVDF HFM in which the outside surface of the hollow fibers was treated with KOH and AA; the extraction system used was the octanol/phenol/water system (system 2); Q_{org}=3.9 ml/min for Q_{aq} variation; Q_{aq}=6.8 ml/min for Q_{org} variation; ΔP≈1 psi (excess pressure on the organic phase).

### DETAILED DESCRIPTION

As discussed herein, porous membranes having a particular wetting characteristic, hydrophobic or hydrophilic, are used for nondispersive membrane solvent extraction (MSX) where two immiscible phases flow on two sides of the membrane. The aqueous-organic phase interface across which solvent extraction/back extraction occurs remains immobilized on one surface of the membrane. This process requires the pressure of the phase not present in membrane pores to be either equal to or higher than that of the phase present in membrane pores; the excess phase pressure should not exceed a breakthrough pressure. In countercurrent MSX with significant flow pressure drop in each phase, this often poses a problem.

To overcome this problem, disclosed herein is a flat porous Janus membrane (e.g., a porous composite membrane) that was developed using either a base fabricated from polypropylene (PP), polyvinylidene fluoride (PVDF), polyamide (Nylon) membrane, or polyetheretherketone (PEEK), one side of which is hydrophobic and the other/opposing side is hydrophilic. Such membranes were characterized using the contact angle, liquid entry pressure (LEP), and the droplet breakthrough pressure from each side of the membrane along with characterizations via scanning electron microscopy (SEM), and Fourier transform infrared spectroscopy (FTIR). Nondispersive solvent extractions were carried out successfully for two systems, octanol-phenol (solute)-water, toluene-acetone (solute)-water, with either flowing phase at a pressure higher than that of the other phase. The phenol extraction system had a high solute distribution coefficient, whereas acetone prefers both phases almost identically. In most of the membranes, the wetting characteristic of the base membrane was changed to the opposite type up to only a small depth of the membrane on one side. With particular porous PVDF membranes, half of the membrane was hydrophobic and the other half was hydrophilic. Janus membranes may be also developed using a base PTFE or ECTFE membrane, one side of which is hydrophobic and the other surface is hydrophilic. The potential practical utility of the MSX technique will be substantially enhanced via Janus MSX membranes.

In one embodiment, the Janus membranes disclosed herein could include: hydrophobic-hydrophilic PVDF obtained by two separate methods; polypropylene with a plasma polymerized and functionalized hydrophilic coating and similarly for PEEK; polyamide (Nylon 6,6) with a plasma polymerized hydrophobic coating. It will be understood that other suitable materials could be used besides PVDF. For example, one can coat one surface of a porous hydrophobic membrane of polytetrafluorethylene (PTFE) with a porous hydrophilic layer of polyvinyl alcohol and then crosslink it with glutaraldehyde to develop a Janus membrane having different wetting characteristics on the two surfaces. In another example, a porous ethylene chlorotrifluoroethylene (ECTFE) may undergo grafting reaction with 4-acryloylmorpholine. (See, e.g., International Patent Publication No. WO 20142046642). Further, one can employ porous hollow fiber membranes instead of flat membranes, one side of which is hydrophobic and the other side is hydrophilic.

These membranes have been characterized on both sides by liquid entry pressure (LEP), contact angle, droplet breakthrough pressure, scanning electron microscopy (SEM), and Fourier transform infrared spectroscopy (FTIR). Solvent extraction performances of selected membranes have been studied using two extraction systems: octanol/phenol/water with a high distribution coefficient for solute species phenol into octanol; toluene/acetone/water with a distribution coefficient of around 1 for extraction of acetone from water into toluene. Nondispersive solvent extraction operation with either phase at a higher pressure has been disclosed.

Experimental

The materials and the methods of the present disclosure used in one embodiment will be described below. While the embodiment discusses the use of specific materials, such as specific membranes, it is understood that the present disclosure could employ other suitable materials. Similar quantities or measurements may be substituted without altering the method embodied below.

Materials and Chemicals

Porous hydrophilic PVDF and hydrophobic PVDF membranes were obtained from MilliporeSigma (Burlington, Mass.). Porous hydrophobic PP membrane was obtained from Celgard (Charlotte, N.C.). Porous polyamide (Nylon 6,6) membrane was obtained from 3M (Saint Paul, Minn.). Details of these original membranes before modification are provided in Table 1 below. Porous PEEK 100 membranes are from Sterlitech (Kent, WA). These membranes were treated later by a number of methods. PVDF membranes whose 50% thickness was hydrophobic and 50% thickness was hydrophilic were provided by MilliporeSigma (Burlington, Mass.).

TABLE 1
Details of original membranes used to create Janus membranes

| | | | Type | Pore | | |
|---|---|---|---|---|---|---|
| Membrane | | Identification | (Hydrophobic/ | Size | Porosity | Thickness |
| Material | Manufacturer | Name | hydrophilic) | (μm) | (%) | (μm) |
| Polypropylene (PP) | Celgard | Celgard 2500 | Hydrophobic | 0.21 | 55* | 30 |
| Polyvinylidene | MilliporeSigma | VVHP | Hydrophobic | 0.1 | 62 | 100 |
| fluoride (PVDF) | | | | | | |
| Polyvinylidene | MilliporeSigma | VVPP | Hydrophilic | 0.1 | 62** | 100 |
| fluoride (PVDF) | | | | | | |
| Polyamide | 3M | BLA020 | Hydrophilic | 0.2 | 65*** | 179 |
| (Nylon 6,6) | | | | | | |

*www.celgard.com;
**Table S.2;
***Generated by method followed for PVDF-VVPP.

Hydrophobic PVDF membranes from MilliporeSigma (Burlington, Mass.) with nominal pore size of 0.1 μm were used to make Janus membranes in-house by functionalizing one side of the membrane. For this embodiment, potassium hydroxide (KOH), acrylic acid (AA, anhydrous), and ammonium persulfate (APS) were obtained from Sigma-Aldrich (St. Louis, Mo.).

Organic solvents, used for membrane solvent extraction runs and analysis, include acetone (certified ACS grade), toluene (certified ACS grade), ethanol (absolute-200 Proof, molecular biology grade), and octanol (Alfa-Aeser, 99%); all were purchased from Fisher Scientific (Hampton, NH). Phenol (loose crystals, ACS reagent) was purchased from Sigma-Aldrich (St. Louis, Mo.). Ultra-high purity (UHP) N₂ gas, also used in membrane solvent extraction, was purchased from Airgas, an Air Liquide Company. Deionized (DI) water, used for MSX experiments and membrane characterization, was obtained from the Barnstead water filtration system in-house.

Membrane Surface Modifications

In general, a very thin layer of the opposite wetting characteristic was developed on one side of the membrane. Surface modification of porous hydrophobic PVDF membranes was performed using KOH and acrylic acid. PVDF membranes were cut and placed in a beaker, floating on top of an aqueous 5M KOH solution. The beaker was then corked with a rubber stopper to avoid evaporation and placed in an oven at 70° C. for either 3, 4, or 5 days. After being taken out of the oven, membranes were removed from the solution and washed with deionized (DI) water. Following this, the newly treated side of the membrane was floated on top of another aqueous solution of 11.1 wt % acrylic acid (AA) and 0.4 wt % APS for 5 min. The membrane was then sandwiched between two glass plates and placed back into the oven for 2 hr. at 90° C. The final membrane was rinsed again with DI water.

For base hydrophilic PVDF membrane samples AKS 6942 A-2, AKS 6942-B-2, AKS-6943 A-4, and AKS-6943 B-4, a thin and highly porous hydrophobic polyfluorosiloxane coating was developed by vacuum-based plasma polymerization on one surface. The coating was developed on the pore mouth and the nearby surface of an existing pore by depositing a small amount of polyfluorosiloxane material that did not reduce the pore size by more than about 118^{th} of the pore size, as an approximation. The ratio of Si/F monomers in these coatings was intentionally kept low at 0.50 to limit the thickness and enhance the hydrophobicity of the surface. Suffix A and B refer to the position of the membrane in the batch reactor vis-à-vis electrodes in the plasma polymerization reactor. Coatings AKS 6942 A-2 and 6942-B-2 were prepared by keeping the treatment time at 2 min, while coatings AKS 6943-A-4 and AKS 6943-B-4 were prepared via a treatment time of 4 min. 1,1,3,3 Tetramethyldisiloxane and perfluorooctane were used as monomers in one embodiment.

The surface modification and process used, particularly for porous polyethersulfone hollow fibers, is discussed in, e.g., Sharma, A. K. et al., Porous hydrophobic-hydrophilic composite hollow fiber and flat membranes prepared by plasma polymerization for direct contact membrane distillation, Membranes, 11, 120 (2021). Some details of the surface modification and process used for flat hydrophilic porous PVDF films are discussed in, e.g., Puranik, A. A. et al., Porous hydrophobic-hydrophilic composite membranes for direct contact membrane distillation, J. Membrane Sci., 591,117225 (2019). These modifications were implemented by Applied Membrane Technology Inc. (AMT) (Minnetonka, MN). One surface of a porous hydrophilic Nylon BLA020 film was modified also into a hydrophobic surface in the sample AKS-7050 in a similar fashion.

When modifying one surface of a hydrophobic PP membrane sample AKS -7048-PP by plasma polymerization, a two-step process was followed in one embodiment. The preparation involved a combination of a Parylene N vacuum deposition process followed by a plasma polymerization vacuum process. In this embodiment, the first step involved deposition of Parylene N coatings into the pores of the PP substrate on one side without pore filling followed by creation of functionalized molecular layers via plasma polymerization. Plasma polymerization was also implemented by AMT Inc. (Minnetonka, MN). Hydrophilization of one surface of PEEK membranes was similarly implemented.

Membrane Characterizations

Membrane morphology study

The cross-sections and surfaces of the Janus and original (hydrophobic or hydrophilic) membranes were studied using scanning electron microscopy (SEM) (SEM—JSM 7900F Field Emission SEM (JEOL USA, Peabody, MA)). Fourier-transform infrared spectroscopy (FTIR) was performed with an Agilent Cary 670 FTIR spectrometer (Santa Clara, Calif.) for FTIR spectra of membrane samples. 16 scans were taken for each sample over 4000-400 cm⁻¹ with a resolution of 4 cm⁻¹. Porosity measurement details for PVDF membranes are provided in Table 2 below.

TABLE 2
Porosity measurement data for PVDF-VVPP hydrophilic membranes
Porosity Measurements for PVDF- VVPP (MilliporeSigma)

| | Dry | Wet | Mass of | Density | V, | Membrane | | |
|---|---|---|---|---|---|---|---|---|
| | weight | weight | water | of water | solvent | volume | Porosity | Average |
| Sample # | (g) | (g) | (g) | (g/mm³) | (mm³) | (mm³) | E | porosity |
| 1 | 0.1185 | 0.2302 | 0.1117 | 0.0010 | 111.7 | 180.677 | 0.618 | 0.611 |
| 2 | 0.1199 | 0.2293 | 0.1094 | 0.0010 | 109.4 | 180.677 | 0.605 | |
| 3 | 0.1190 | 0.2306 | 0.1116 | 0.0010 | 111.6 | 180.677 | 0.617 | |
| 4 | 0.1200 | 0.2289 | 0.1089 | 0.0010 | 108.9 | 180.677 | 0.602 | |

Wetting Properties

Contact angle as used herein refers to the angle at which the liquid-vapor interface meets a solid surface and, therefore, quantifies the wettability of the surface. An angle between 0° and 90° signifies that the aqueous droplet wets the surface to some degree and thus the surface is hydrophilic. An angle from 90° to 180° indicates a hydrophobic surface. The higher the value of the contact angle, the greater the hydrophobicity. The contact angles were determined using optical tensiometry (Model No. A 100, Rame-Hart Inc., Succasunna, NJ). An approximately 10 μL drop of distilled water was placed on each side of the membrane and the angle was measured through the optical lens.

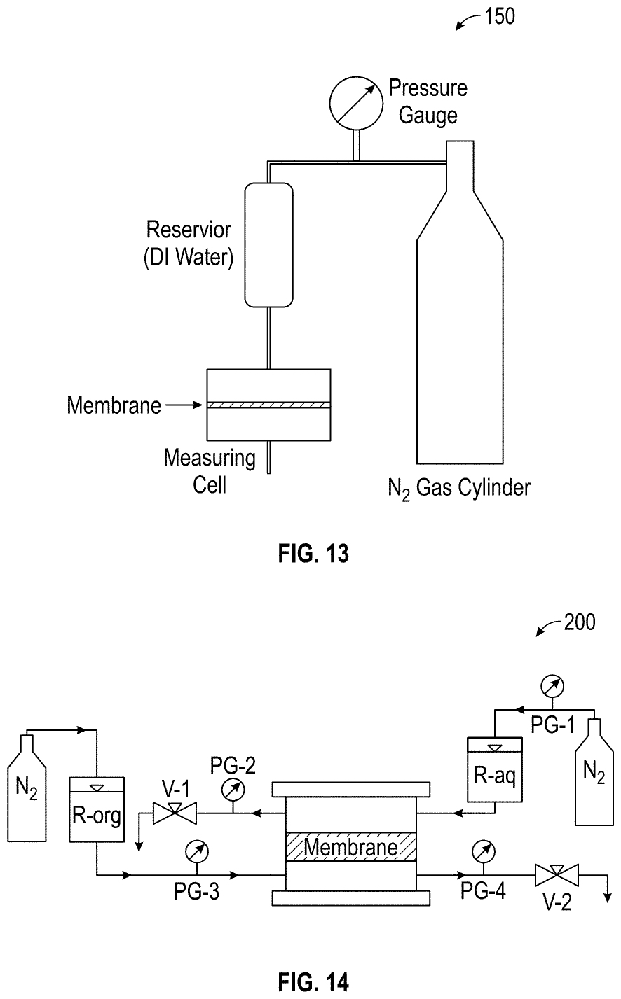

The LEP as used herein refers to the minimum pressure at which a liquid will break through the largest pore of the membrane. The experimental set up 150 for obtaining such a pressure is diagrammatically illustrated in FIG. 13. (See, e.g., Yao, N. et al., Characterization of Microporous ECTFE Membrane after Exposure to Different Liquid Media and Radiation, J. Membrane Sci., 532, 89-104 (2017)). The membrane was placed in a cell and a water-filled reservoir was connected to the top of the membrane. Nitrogen gas was slowly pressurized and pushed the liquid out of the reservoir and into the membrane. The pressure at which the liquid (water) was observed coming out of the cell continuously was determined as the LEP.

Studies in the droplet breakthrough pressure (ΔP_{B}) test was an experiment designed to determine the maximum phase pressure difference that can be used in a solvent extraction system before one phase breaks through into the other phase. Before performing MSX experiments, membranes were tested with the droplet breakthrough test to see whether dual wettability (one side of the membrane is wetted by an aqueous phase whereas the other side is wetted by an immiscible organic phase) works. The test set up 200 is diagrammatically shown in FIG. 14. In FIG. 14, N₂ represents compressed nitrogen, PG represents a pressure gauge, R-org represents a solvent feed reservoir, R-aq represents an aqueous feed reservoir, and V represents a needle valve. A test liquid A (e.g., DI water) was pressurized on one side of the membrane, while test liquid B (e.g., toluene) was held at a constant pressure on the other side of the membrane. The pressure of liquid A was increased by 6.86 kPa (1 psi) every 2 min until a drop of the test liquid A was seen breaking through into test liquid B. Clear PTFE tubing was used in the set-up and was important to be able to see the droplet breaking through. Since either phase can be run at a pressure higher than the other, there are two breakthrough pressures: ΔP_{org} is the breakthrough pressure difference required for the organic phase to break into the aqueous phase; ΔP_{aq} is the breakthrough pressure difference required for aqueous phase to break into the organic phase. An interfacial tensiometer (model 70545; CSC Scientific Company, Inc., Fairfax, Va.) was used to measure the surface and interfacial tensions of the various liquids and systems using the Du Nouy ring method.

Membrane Solvent Extraction

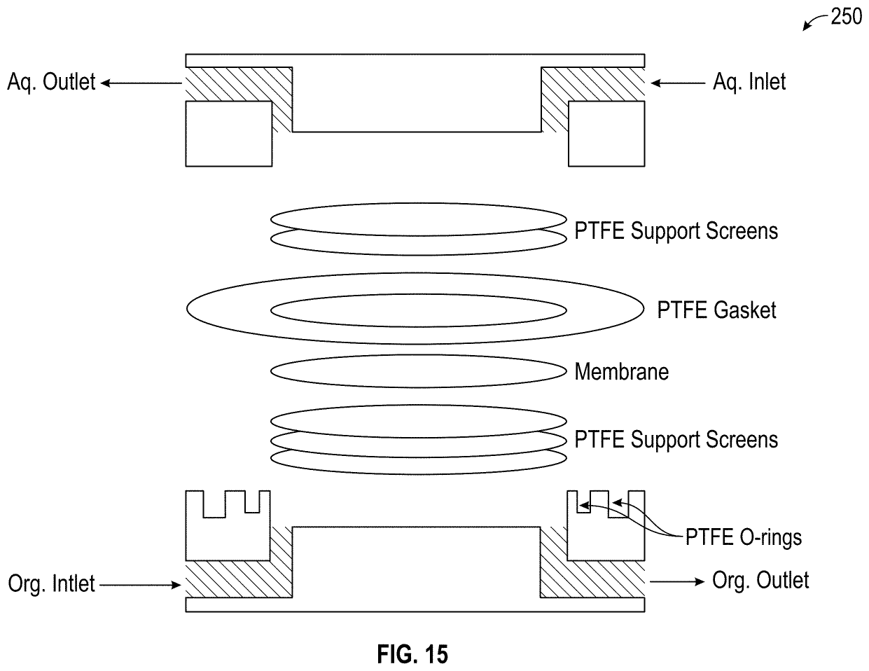

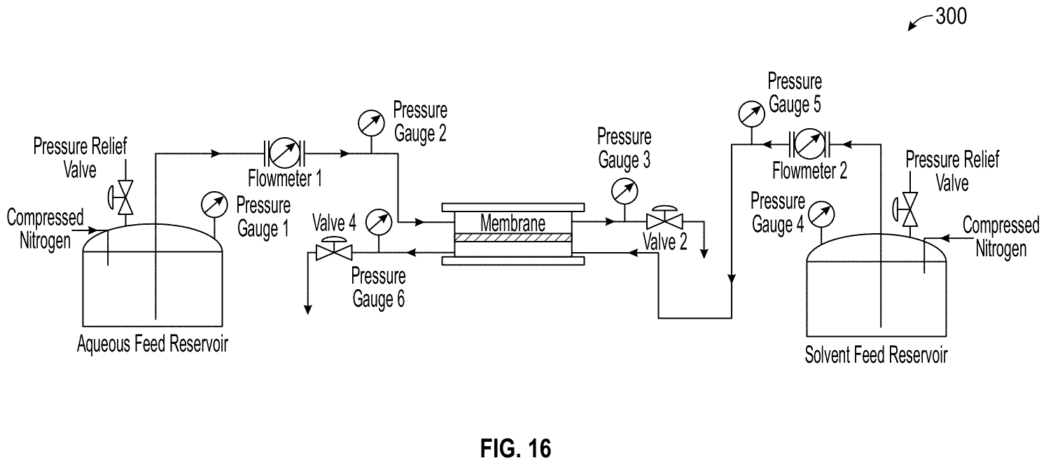

Membrane solvent extraction was carried out in a small PTFE cell 250 made in-house with an active membrane area of 9.55 cm² (see, e.g., FIG. 15). A PTFE support (ET8200, Industrial Netting) was used above and below the membrane to fill in the excess space in the cell and support the membrane on both sides such that the membrane was not damaged with the excess pressure (be it on either side) during MSX. The cell also used a PTFE gasket, placed above the membrane, to help seal the cell. A schematic of the system 300 can be seen in FIG. 16. Experiments were performed using an aqueous-solute-organic system of either octanol-phenol-water (system 1) or toluene-acetone-water (system 2). The aqueous feed for system 1 consisted of 0.1 g/L phenol in water while that of system 2 contained approximately 15% acetone in water.

At the start of any MSX experiment, the aqueous solution was run through the top half of the cell for a couple of minutes before the organic reservoir was pressurized by N2 and allowed to flow out. Once the system was stabilized (maintained the same flow rate and pressures) for approximately 5 min, a sample was taken. After the sample was taken, either the flow rate or the pressure was changed and stabilized before taking another sample. Each sample was collected for approximately 5-7 min.

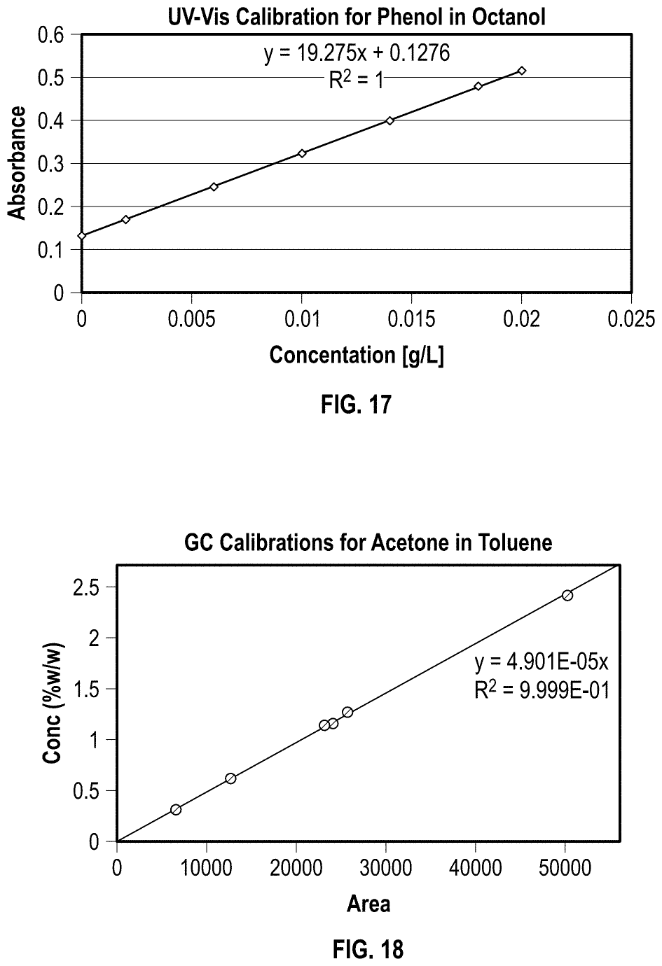

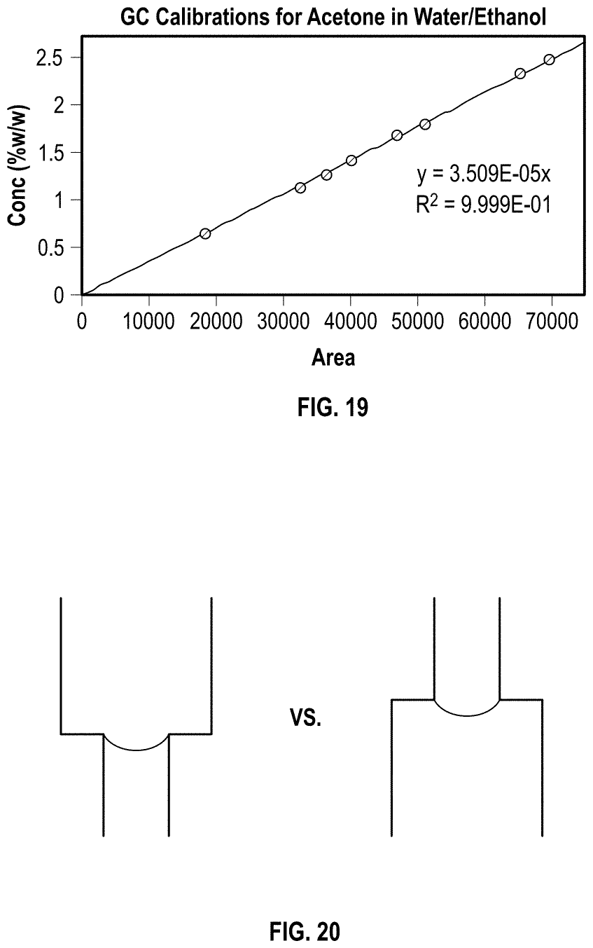

For system 1, organic samples were collected and analyzed via UV-Vis with a temperature controller (Varian, Cary 50, Agilent, Santa Clara, Calif.). The concentration of each sample was measured at a wavelength of 273 nm (see, e.g., FIG. 17). For system 2, aqueous and organic samples were both collected and analyzed via gas chromatography (GC, HP 6890 Series with flame ionization detector) with a DB 5 ms column (Agilent, Santa Clara, Calif.). The aqueous samples were first diluted with ethanol before being analyzed (see, e.g., FIGS. 18 and 19).

The distribution coefficient mᵢ of solute species i, the overall organic phase-based species i mass transfer coefficient, K̅ₒ, and ΔC|_{LM} indicating the logarithmic mean concentration driving force for species i are indicated by Equations 1-3, respectively.

$${m}_{i} = \frac{{c}_{io}}{{c}_{iw}} \qquad ( 1 )$$

$${\overline{K}}_{o} = \frac{( {Q}_{or} {c}_{io}^{b} {\vert}_{exit} )}{Δ C {\vert}_{LM} {A}_{m}} \qquad ( 2 )$$

$$Δ C {\vert}_{LM} = \frac{( Δ {C}_{1} - Δ {C}_{2} )}{ln ( \frac{Δ {C}_{1}}{Δ {C}_{2}} )} \qquad ( 3 )$$

$${Δ {C}_{1} = {m}_{i} {C}_{iw}^{b} {\vert}_{im} - {C}_{io}^{b} \vert}_{exit} \qquad ( 4 )$$

$$Δ {C}_{2} = {m}_{i} {C}_{iw}^{b} {\vert}_{exit} \qquad ( 5 )$$

In Equations 1-5, Qₒᵣ is organic phase flow rate, Aₘ is the membrane surface area, and Cᵢₒ^{b} and C^{b}_{iw} are the bulk solute concentration of species i in organic phase and aqueous phase, respectively. The mᵢ value of system 1 was estimated experimentally by stirring together 50 mL of a water-phenol solution with a concentration of 0.1 g phenol/L with 50 mL of octanol for 4 hr. The resulting organic phase concentration was then measured via UV-Vis and the m, value calculated using Equation 1. The m, for system 2 was obtained from literature. (See, e.g., Misek, T. et al., Standard Test Systems for Liquid Extraction, European Federation of Chemical Engineering Working Party on Distillation, Absorption and Extraction, 2nd Edition (1985)).

Results and Discussion

Membrane Characterization

In this embodiment, a few commercial flat membranes were obtained and treated on one side either via a plasma polymerization-based coating or by a KOH and acrylic acid treatment as described above. The list of original membranes as well as their details is provided in Table 1 (above).

TABLE 3
Characterization results of various Janus membranes

| | Contact Angle [°] | | LEP [kPa (psi)] | | ΔPs [kPa (psi)] | | ΔPs [kPa (psi)] | |
|---|---|---|---|---|---|---|---|---|
| | (water) | | (water) | | (water-toluene) | | (water-octanol) | |
| Designation # | Treated | Non-treated | Treated | Non-treated | ΔP_{org} | ΔP_{aq} | ΔP_{org} | ΔP_{aq} |

Hydrophilic coated with hydrophobic
PVDF- VVPP-original hydrophilic membrane

| AKS- 6942 | 126 | 66 | 255.1 | (37) | 172.4 | (25) | 186.2 | (27) | 68.9 | (10) | NT | NT |
|---|---|---|---|---|---|---|---|---|---|---|---|---|
| A-2 | | | | | | | | | | | | |
| AKS- 6942 | 114 | 39 | 344.7 | (50) | 220.6 | (32) | 213.7 | (31) | 62.1 | (9) | NT | NT |
| B-2 | | | | | | | | | | | | |
| AKS-6943 | 134 | 70 | 310.3 | (45) | 227.5 | (33) | 206.8 | (30) | 82.7 | (12) | NT | NT |
| A-4 | | | | | | | | | | | | |
| AKS- 6943 | 126 | 73 | 296.5 | (43) | 220.6 | (32) | 193.1 | (28) | 103.4 | (15) | NT | NT |
| B-4 | | | | | | | | | | | | |

Nylon- BLA020-original hydrophilic membrane

| | | | | | | | | | | | | |
|---|---|---|---|---|---|---|---|---|---|---|---|---|
| AKS- 7050 | 126 | 43 | 89.6 | (13) | 75.8 | (11) | NT | NT | >13.8 | (>2) | 20.7 | (3) |

| | | | | | | | | | |
|---|---|---|---|---|---|---|---|---|---|
| Original | NA | 40 | NA | 0 | NT | NA | 20.7 | (3) | NA |

Hydrophobic coated with hydrophilic
PP- Celgard 2500

| | | | | | | | | | | | | | |
|---|---|---|---|---|---|---|---|---|---|---|---|---|---|
| AKS 7048 | 59 | 104 | >413.7 | (>60) | >413.7 | (>60) | 124.1 | (18) | NT | 234.4 | (34) | >413.7 | (>60) |

| | | | | | | | | | | | |
|---|---|---|---|---|---|---|---|---|---|---|---|
| Original | NA | 105 | NA | >413.7 | (>60) | NA | >413.7 | (>60) | NA | 372.3 | (54) |

KOH and AA treated (hydrophobic membrane hydrophilized on one side)
PVDF- VVHP-original hydrophobic membrane

| | | | | | | | | | | | | |
|---|---|---|---|---|---|---|---|---|---|---|---|---|
| Sample 1 | 24 | 121 | 317.2 | (46) | 310.3 | (45) | 165.5 | (24) | 296.5 | (43) | NT | NT |
| (5-day) | | | | | | | | | | | | |
| Sample 2 | 30 | 114 | 320.6 | (46.5) | 313.7 | (45.5) | 199.9 | (29) | 296.5 | (43) | NT | NT |
| (4-day) | | | | | | | | | | | | |

| | | | | | | | | | | | |
|---|---|---|---|---|---|---|---|---|---|---|---|
| Sample 3 | 35 | 118 | 330.9 | (48) | 318.5 | (46.2) | 165.5 | (24) | NT | NT | NT |
| (3-day) | | | | | | | | | | | |

| | | | | | | | | | | |
|---|---|---|---|---|---|---|---|---|---|---|
| Original | NA | 116 | NA | 337.8 | (49) | NA | 289.6 | (42) | NT | NT |

NA: Not applicable;
NT: Not tested

Table 3 (above) provides the characterization results of the surface-treated Janus membranes with respect to contact angle, LEP value, and breakthrough pressure for the aqueous-organic interface. Contact angle measurements show clearly that dual wettability was achieved for each membrane by both treatment methods. As understood previously, in plasma polymerization-based treatment of hydrophilic membranes, a thin hydrophobic coating was deposited on one side of a membrane and therefore decreased the pore sizes of the treated side of the membrane. (See, e.g., Puranik, A. A. et al., Porous hydrophobic-hydrophilic composite membranes for direct contact membrane distillation, J. Membrane Sci., 591,117225 (2019)). For this reason, the LEP values were always higher when pressurizing water from the hydrophobic coating side on a hydrophilic substrate (see, e.g., FIG. 20). However, for alkali-treated hydrophobic PVDF membranes, surface hydrophilization/modification took place, and the pore size hardly changed. As a result, the LEP values were changed very little.

Breakthrough pressures were obtained by testing pure solvent (either toluene or octanol) with pure water. No solutes were involved to minimize inconsistencies. Addition of solutes in the system will decrease the interfacial tension of the system and, therefore, decrease the breakthrough pressure. In a traditional hydrophobic or hydrophilic membrane, either the organic or the aqueous phase will fill the pores, respectively. With a hydrophilic membrane, one can fill up the pores with the organic phase as well under appropriate conditions if not dealing with a hydrogel. To create an immobilized aqueous-organic interface, the pressure of the non-wetting phase needs to be maintained at a higher pressure. The pressure of the wetting phase can never exceed that of the non-wetting phase or else it will become dispersed into the non-wetting phase as droplets.

The Janus membranes, having one side hydrophobic, filled with organic phase and one side hydrophilic, filled with aqueous phase, can withstand an excess phase pressure on either side. From Table 3 (above), it is observed that the non-wetting phase of the base membrane (e.g., organic phase in the PVDF AKS 6942 A-2) had a higher breakthrough pressure than that of the wetting phase of the base membrane. This was due to the modification of the pore radius/structure via plasma polymerization, as described previously. The treatments were, however, quite successful, as the aqueous-organic interface could withstand significant pressures before breakthrough occurred. The hydrophilized side of the PP membrane was stable in 1N HCl solution for seven days (experiment terminated on 8th day) for potential use in solvent extraction of actinides.

Table 4 (below) provides simple estimates of the breakthrough pressure of the aqueous-organic phase interface using Young-LaPlace equation and comparing the calculated value with the observed value for a given modified membrane. Using measured LEP values with water and Young-LaPlace equation (Equation 6) without any corrections/modifications, an estimate was first developed for the value of r_{p,max}, the maximum pore radius in the membrane, on both sides. The contact angles (θ) of the hydrophilic sides were assumed to be 0 as water will enter the pores. This estimate was then used in Young-LaPlace equation, along with the interfacial tension for the aqueous-organic system, to predict the breakthrough pressure AP_{B} for the membrane under consideration. Before discussing the results of such calculations, it is pointed out that the values of r_{p,max} calculated for PVDF-VVHP membranes were quite close to the corresponding estimates from bubble-point pressure measurements for the same base membrane in an earlier study, where the value estimated was 0.23 μm. (See, e.g., Li, L. et al., Influence of Microporous Membrane Properties on the Desalination Performance in Direct Contact Membrane Distillation, J. Membrane Sci., 513, 280-293 (2016)).

$$LEP = - {γ}_{L} cos θ \frac{2}{{r}_{max}} \qquad ( 6 )$$

TABLE 4
Breakthrough pressure estimates for a few Janus membranes for toluene-water system

| | | | | | ΔPs | | ΔPs | |
|---|---|---|---|---|---|---|---|---|
| | Experimental LEP | | r_{p, max} | | kPa (psi) | | kPa (psi) | |
| | kPa (psi) (water) | | (μm) calculated | | (treated surface) | | (non-treated surface) | |
| Designation # | Treated | Non-treated | Treated | Non-treated | Measured | Calculated | Measured | Calculated |

Hydrophilic coated with hydrophobic
PVDF-VVPP

| | | | | | | | | | | | | | | |
|---|---|---|---|---|---|---|---|---|---|---|---|---|---|---|
| AKS- 6942 | 255.1 | (37) | 172.4 | (25) | 0.40 | 0.84 | 186.2 | (27) | 188.6 | (27.4) | 68.9 | (10) | 90.1 | (13.1) |
| A-2 | | | | | | | | | | | | | | |
| AKS- 6942 | 344.7 | (50) | 220.6 | (32) | 0.17 | 0.66 | 213.7 | (31) | 443.1 | (64.3) | 62.1 | (9) | 115.4 | (16.7) |
| B-2 | | | | | | | | | | | | | | |
| AKS-6943 | 310.3 | (45) | 227.5 | (33) | 0.32 | 0.64 | 206.8 | (30) | 233.5 | (33.9) | 82.7 | (12) | 119.0 | (17.3) |
| A- 4 | | | | | | | | | | | | | | |
| AKS- 6943 | 296.5 | (43) | 220.6 | (32) | 0.29 | 0.66 | 193.1 | (28) | 260.6 | (37.8) | 103.4 | (15) | 115.4 | (16.7) |
| B-4 | | | | | | | | | | | | | | |

KOH and AA treated (hydrophobic membrane hydrophilized on one side)
PVDF- VVHP

| | | | | | | | | | | | | | | |
|---|---|---|---|---|---|---|---|---|---|---|---|---|---|---|
| Sample 1 | 317.2 | (46) | 310.3 | (45) | 0.46 | 0.24 | 296.5 | (43) | 165.8 | (24.0) | 165.5 | (24) | 315.0 | (45.7) |
| (5-day) | | | | | | | | | | | | | | |
| Sample 2 | 320.6 | (46.5) | 313.7 | (45.5) | 0.45 | 0.19 | 296.5 | (43) | 167.6 | (24.3) | 199.9 | (29) | 403.2 | (58.5) |
| (4-day) | | | | | | | | | | | | | | |

| | | | | | | | | | | | | | |
|---|---|---|---|---|---|---|---|---|---|---|---|---|---|
| Sample 3 | 330.9 | (48) | 318.5 | (46.2) | 0.44 | 0.21 | NT | 173.0 | (25.1) | 165.5 | (24) | 354.7 | (51.5) |
| (3-day) | | | | | | | | | | | | | |

| | | | | | | | | | | | |
|---|---|---|---|---|---|---|---|---|---|---|---|
| Original | NA | 337.8 | (49) | NA | 0.19 | NA | NA | 289.6 | (42) | 402.9 | (58.4) |

NA: Not applicable;
NT: Not tested

In Table 4, AP_{B} of the treated and untreated side correspond to the breakthrough pressures of the non-wetting and wetting phase of the original membrane, respectively. For these calculations, the contact angle in the Young-LaPlace equation was again 0, as the aqueous phase will completely wet the hydrophilic side and the organic phase will completely wet the hydrophobic side. The aqueous-organic system considered was water-toluene with an interfacial tension of 37.8 dyne/cm. The Young-LaPlace equation was used to reasonably predict the breakthrough pressures. For the KOH and AA treated membranes, the calculated values of the treated and non-treated surfaces appear to be switched when compared to the measured values. This is a limitation of the current method, which estimates that the largest pore is on the hydrophobic side, due to the larger contact angle in the Young-LaPlace equation. Due to this, the estimated breakthrough pressure was higher on the hydrophobic side, which is not always the case based on the results of Table 3. Differences between the measured and calculated values may also be due to poor representation of pore shape (see, e.g., Hereijgers, J. et al., Breakthrough in a Flat Channel Membrane Microcontactor, Chemical Engineering Research and Design, 94, 98-104 (2015)), as well as defects within the coatings and the membrane themselves.

Membrane Solvent Extraction

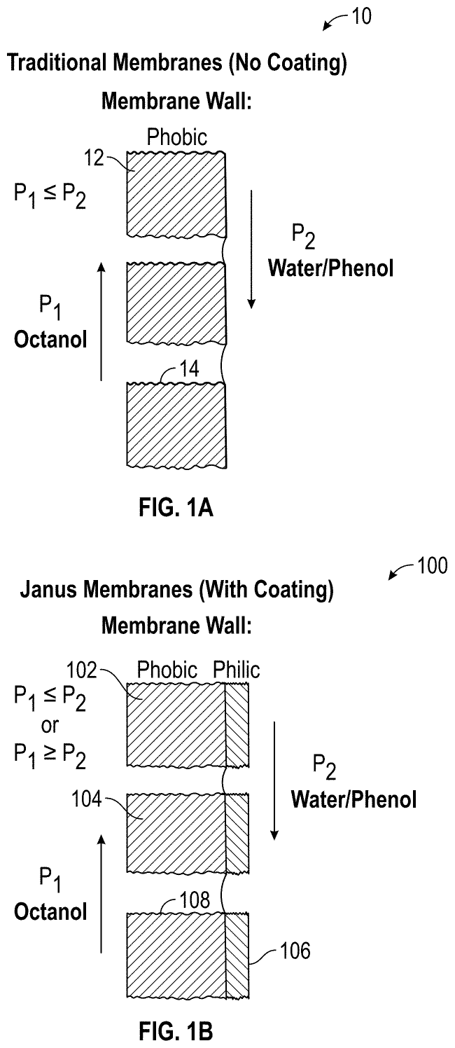

FIGS. 1A and 1B show a comparison between nondispersive solvent extraction pressure constraints in a traditional hydrophobic membrane (FIG. 1A) and a Janus membrane (FIG. 1B) with asymmetric wettability. The traditional hydrophobic membrane 10 of FIG. 1A only includes a membrane wall 12 having hydrophobic characteristics. The wall 12 includes multiple pores 14 extending therethrough. P₁ is the pressure of the organic octanol phase wetting the pores of the hydrophobic membrane; P₂ is the pressure of the aqueous phase on the other side of the membrane and not present in the pores of the hydrophobic membrane. For nondispersive operation, pressure Pi should be ≤P₂; and the magnitude of the difference should be less than a critical breakthrough pressure, ΔP_{crit}. When P₂-P₁ exceeds this value, the aqueous phase will displace the organic phase from the pores and then it will be dispersed as aqueous droplets in the organic phase. Although FIG. 1A shows a hydrophobic membrane for traditional nondispersive solvent extraction, it may be replaced by a hydrophilic membrane, with an aqueous phase in the pores and an organic phase outside at a higher pressure.

Nondispersive solvent extraction runs were performed using membranes listed in Tables 1 and 3. Traditionally, fully hydrophobic membranes used in MSX require the pressure of the aqueous, non-wetting, phase to be higher than or equal to that of the organic, wetting phase, such that the organic phase cannot break through into the aqueous phase. With an exemplary Janus membrane, where one side is hydrophobic and the other hydrophilic, this pressure limitation is non-existent. FIGS. 1A and 1B illustrate this conceptually. In particular, as illustrated in FIG. 1B, the exemplary membrane 100 includes a membrane wall 102 with one side 104 having hydrophobic characteristics and the opposing side 106 having hydrophilic characteristics. The wall 102 includes openings or pores 108 extending therethrough.

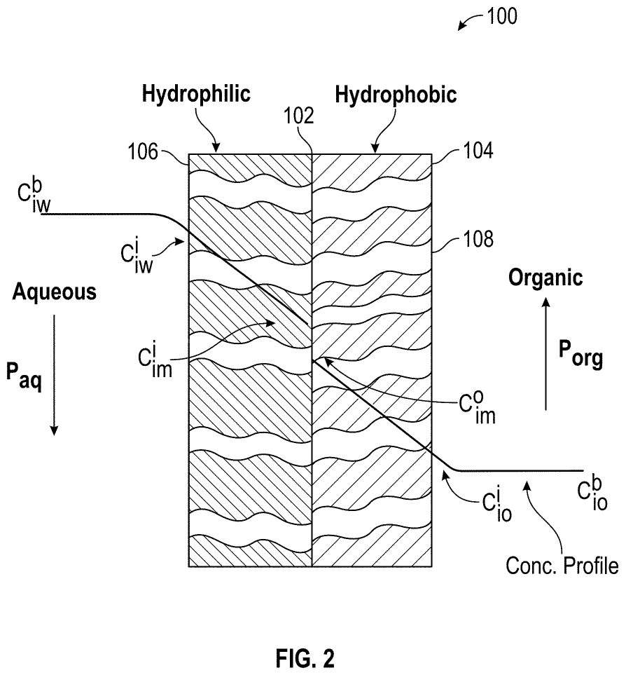

Because each liquid phase ultimately is in contact with a piece of the membrane material that was wetted by the other immiscible phase, which cannot just be displaced, it is physically constrained and therefore the separation of phases throughout the solvent extraction system was maintained. Either phase could now be held at a higher pressure so long as the critical excess pressure difference (the breakthrough pressure difference, AP_{B}) from either side was not achieved. The location of the immobilized interface between the two phases (across which the solute was transferred) had changed from the surface of the porous membrane to somewhere inside the composite membrane (depending on the depth of the coating/surface modification). Membrane solvent extraction could still be carried out successfully as the interface between the two phases still clearly existed. FIG. 2 illustrates the concentration profile in such an MSX system. FIG. 2 shows the concentration profile of a solute being transferred from one phase to the other in MSX for a composite hydrophobic-hydrophilic membrane, e.g., an exemplary Janus membrane.

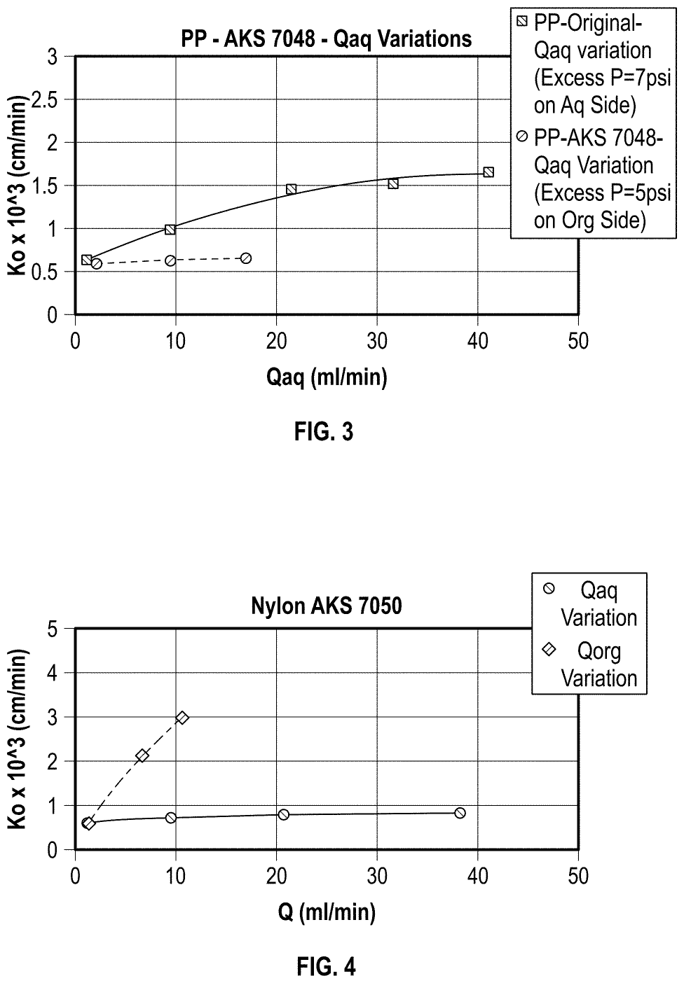

Membrane solvent extraction was carried out using the octanol/phenol/water system (system 1) with a solute (phenol) distribution coefficient mᵢ (defined by Equation 1, above) value of −0.25.6. FIG. 3 shows the results of using an original hydrophobic PP membrane (Celgard 2500), as well as a hydrophobic PP membrane of which one surface was modified (AKS 7048) to make it a Janus membrane. Here, the organic phase-based overall mass transfer coefficient (Kₒ) has been plotted against the aqueous flow rate (Qa_{q}) for a specific organic flow rate (Qₒᵣ). For an original Celgard 2500 membrane, a ΔP of 48.3 kPa (7 psi), with the excess pressure being on the aqueous side, was maintained throughout the experiment. However, for the PP-based AKS 7048 Janus membrane, a AP of 34.5 kPa (5 psi), with excess pressure on the organic side, was maintained. This demonstrated that nondispersive MSX can be successfully carried out with an excess liquid phase pressure on the organic side of a base hydrophobic membrane.

The observed behavior of mass transfer coefficient in FIG. 3, with a variation in aqueous flow rate, is reasonable since mᵢ is >>1 for which it is known that aqueous phase transport resistance controls in hydrophobic membranes. (See, e.g., Prasad, R. et al., Dispersion-free Solvent Extraction with Microporous Hollow Fibers, AIChE J., 34, 177-188 (1988)). Hence, as the aqueous phase flow rate increases, the overall transport resistance decreases. On the other hand, with a Janus membrane having an aqueous layer inside the membrane on the other side, the aqueous side resistance is significantly increased. Correspondingly, aqueous flow rate variation effect is significantly muted.

One cannot however conclude that a Janus membrane is not as effective for mass transfer. For example, in back extraction of a solute from an organic phase into an aqueous phase with the solute preferring the aqueous phase, a hydrophobic membrane with organic phase inside the pores will have a high mass transfer resistance. A Janus membrane will have significantly reduced resistance, since part of the pore length is now occupied by the aqueous phase having a low resistance.

A hydrophilic nylon substrate hydrophobized on one side (AKS 7050) was also used in the octanol/phenol/water system. FIG. 4 plots Kₒ as a function of Q_{aq} and Q_{org} while maintaining a AP of 11.4 kPa (1.6 psi) with excess pressure on the aqueous side. This further proves that regardless of the substrate (whether originally hydrophobic or hydrophilic), nondispersive MSX can be carried out using a Janus membrane.

The behavior of the mass transfer coefficient in FIG. 4 with either phase flow rate variation can also be explained. In the originally hydrophilic nylon membrane with a m, >>1 system, the membrane aqueous phase resistance is high. An increase in aqueous phase flow rate provides little mitigation; therefore, the overall mass transfer coefficient in the surface-modified membrane increases very slowly with Qa_{q}. However, a small increase in Q_{org} increases Kₒ significantly, since now in the modified membrane, organic phase resistance has increased a bit due to a small hydrophobized thickness in the membrane; increased organic flow rate mitigates it.

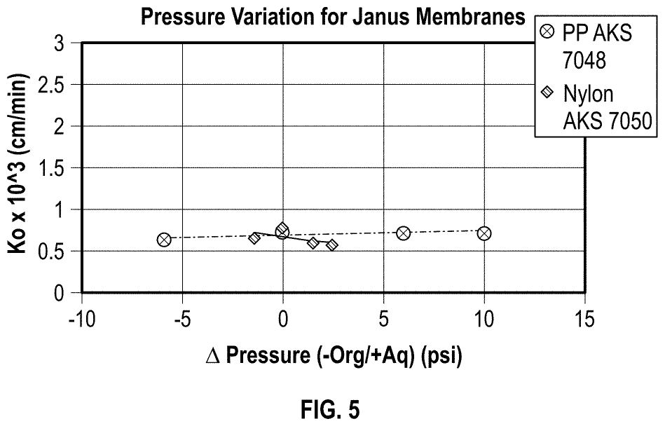

Experiments were also carried out varying the AP in various systems, testing excess pressure in either the organic or the aqueous phase, while maintaining a constant organic and aqueous flow rate. FIG. 5 illustrates the behavior for such conditions for two different Janus membranes, PP-AKS-7048 and Nylon AKS 7050. The overall mass transfer coefficient, Kₒ, did not change significantly with varying pressure on either side of these membranes, which is consistent with the concept of nondispersive MSX.

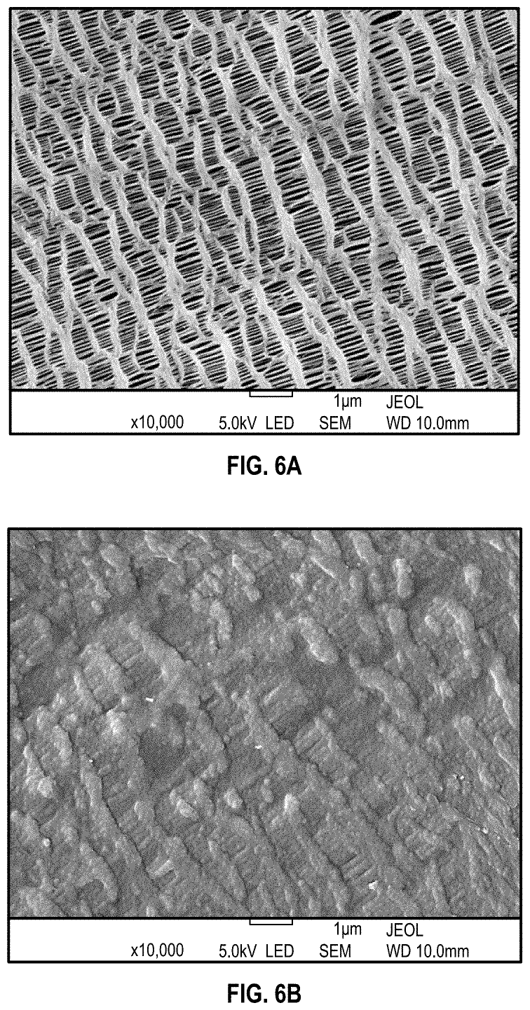

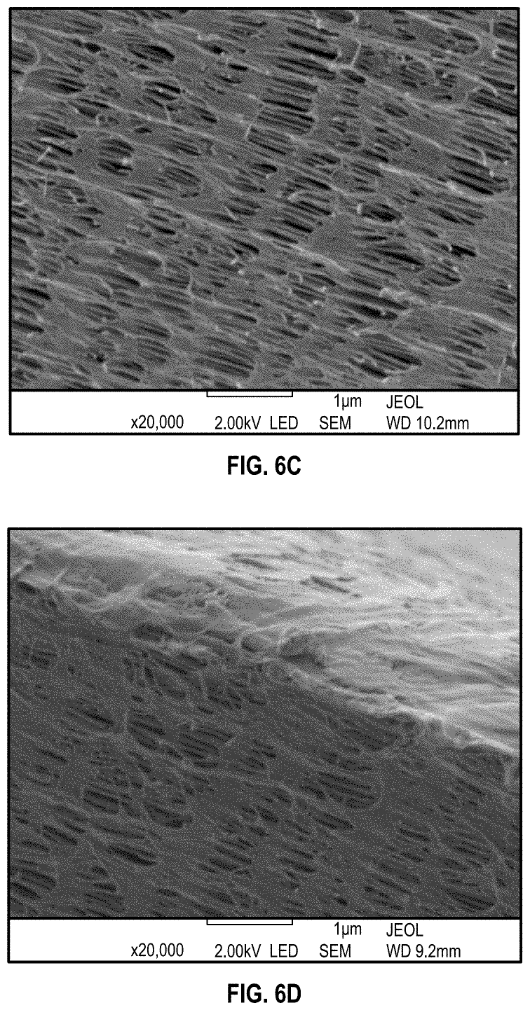

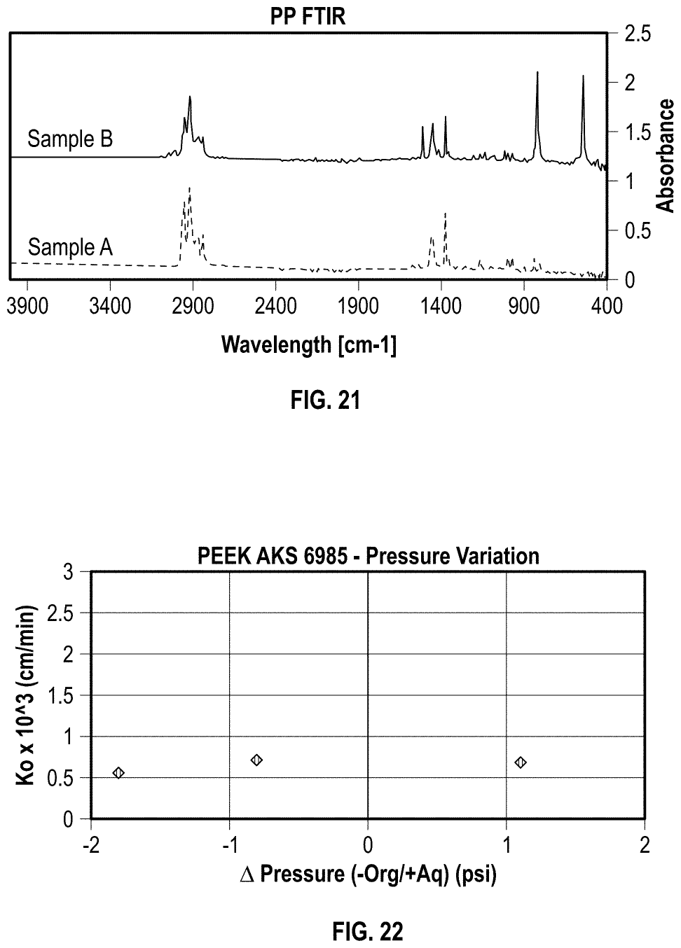

The SEM micrographs of the surfaces and cross-sections of original Celgard 2500 and treated AKS 7048 are shown in FIGS. 6A-6D. The plasma-polymerized coating on the Celgard 2500 covers the entire surface of the membranes and decreases the pore size at the surface. The cross section in FIG. 6D shows that the thickness of the coating is ultra-thin. FIG. 21 provides the FTIR spectra of the hydrophilized side of PP membrane vis-à-vis the original PP membrane.

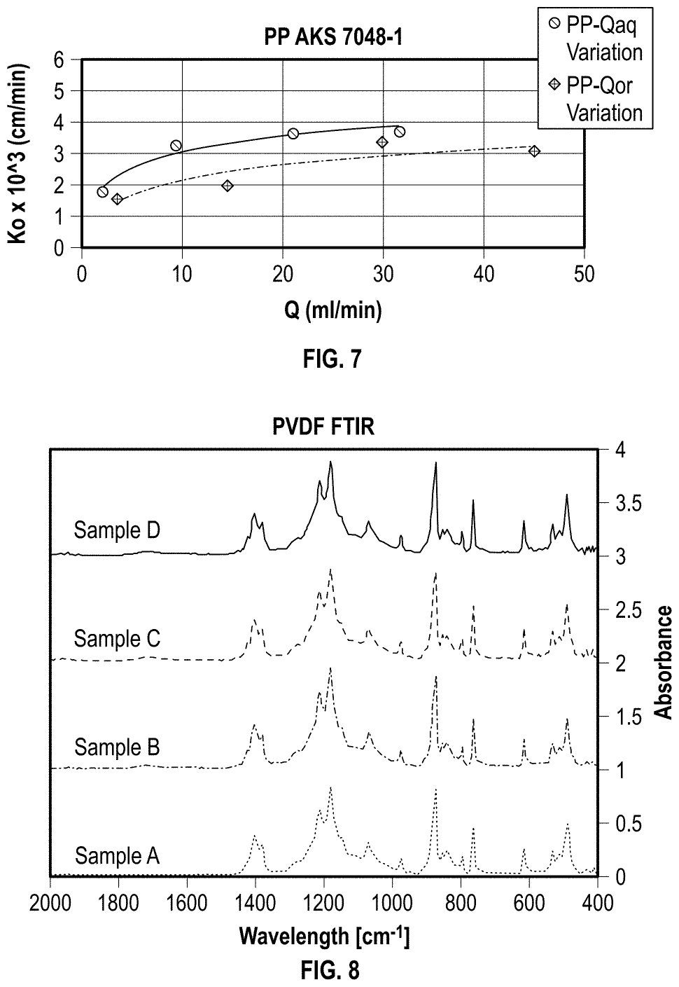

Another chemical system (toluene-acetone-water) was used to study nondispersive MSX with Janus membranes. This system, system 2, has a solute (acetone) distribution coefficient mᵢ of 0.938, much lower than that of the system 1. Since the value of mᵢ is approximately 1, acetone is almost equally favored by both the aqueous and the organic phase. The membrane PP-AKS 7048 with a base hydrophobic PP membrane hydrophilized at the other end was also used with this system. The aqueous and organic flow rates were varied while the pressure difference was maintained at 34.5 kPa (5 psi) with the organic phase being at a higher pressure (FIG. 7). Varying either flow rate achieved approximately the same Kₒ values (subject to individual side fluid mechanics), indicating that the hydrophilic surface modification did not add a significant resistance to the system.

Turning now to PVDF membranes, the FTIR spectra of PVDF membranes (FIG. 8) show that the AA treatment functionalized and stabilized the hydrophilization of the surface of a hydrophobic membrane. It can be seen from FIG. 8 that around 1720 cm⁻¹, there is a hint of a peak for samples B, C, and D (treated PVDF samples). It is the same peak found in the functionalized/hydrophilized PVDF membranes in a previous study (see, e.g., Xiao, L. et al., Polymerization and Functionalization of Membrane Pores for Water Related Applications, Ind. Eng. Chem. Res., 54, 4174-4182 (2015)), where the first step involves KOH treatment (see, e.g., Brewis, D. M. et al., Pretreatment of Poly (vinyl fluoride) and Poly (vinylidene fluoride) with Potassium Hydroxide, Int. J. Adhesion and Adhesives, 16, 87-95 (1996)). Because the membranes studied and discussed herein received only a slight treatment on one side, the peak is much less intense than the peak found in previous studies, where the whole membrane was hydrophilized. (See, e.g., Xiao, L. et al., Polymerization and Functionalization of Membrane Pores for Water Related Applications, Ind. Eng. Chem. Res., 54, 4174-4182 (2015)).

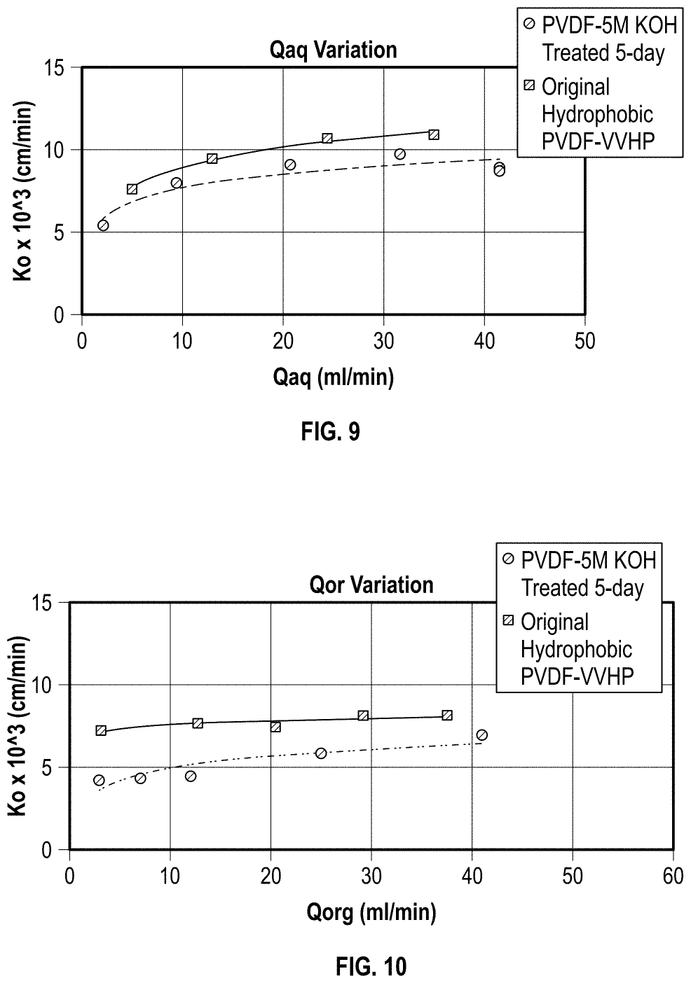

The results of studies with PVDF membranes used in MSX experiments are shown in FIGS. 9 and 10. In particular, FIGS. 9 and 10 compare results of an original hydrophobic PVDF membrane and a membrane treated on one side for 5 days with KOH followed by an AA treatment. The KOH/AA treated membrane was run with a AP of about 69 kPa (10 psi), with excess pressure on the organic side, while the original was run at a AP of about 10 psi, with excess pressure on the aqueous side.

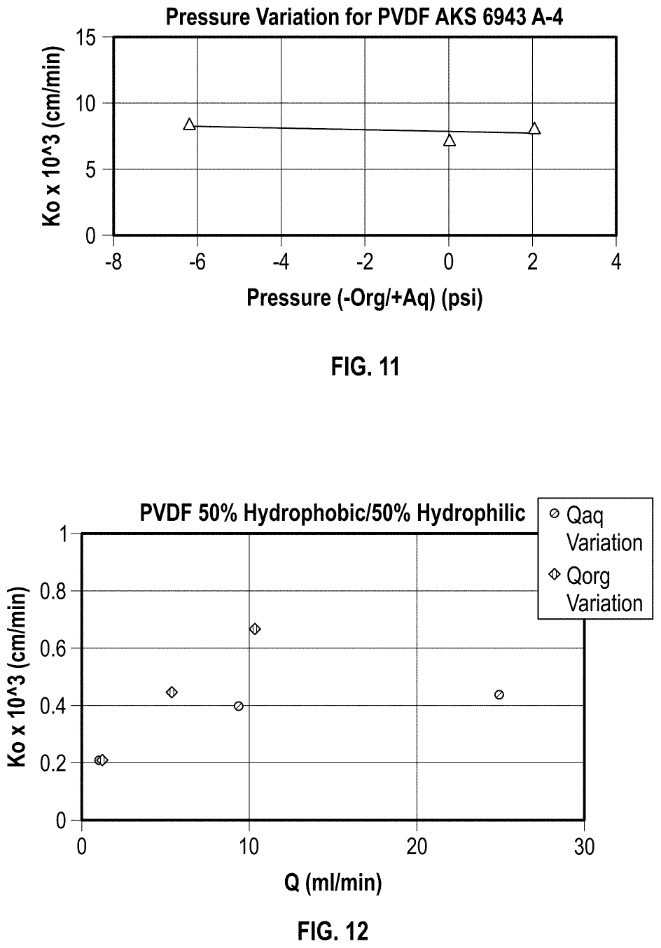

In FIG. 9, the variation of the overall mass transfer coefficient with aqueous phase flow rate variation is illustrated. With the extraction system of toluene/acetone/water, the effect of aqueous phase flow rate variation is quite similar for both membranes since the membrane section, whether it is hydrophobic or hydrophilic, will behave in a similar fashion for the KOH-treated membranes. The treated membrane performs almost on par with the original membrane, again proving the success and benefit of Janus membranes for use in MSX. A somewhat similar behavioral pattern is observed in FIG. 10 for these membranes when organic phase flow variation is studied. For the originally hydrophilic PVDF membrane, hydrophobized on one side by plasma polymerization process, AKS-6943A-4, the pore size becomes reduced leading to an increase in membrane resistance. In FIG. 11, it can be seen that the increase in membrane resistance reduces the overall mass transfer coefficient Kₒ a bit. In FIG. 11, the main goal is to show that increased pressure on either side of the membrane does not essentially affect the mass transfer rate for given aqueous and organic phase flow rates.

The possibility of carrying out nondispersive MSX with composite membranes having different wetting properties on two sides of the membrane can also be extended to one side having some solute selectivity due to the membrane structure. A graphene oxide laminate based composite membrane would then become useful in such a context. (See, e.g., Peng, C. et al., Graphene Oxide-based Membrane as Protective Barrier against Toxic Vapors and Gases, ACS Appl. Mater. Interfaces, 12, 11094-11103 (2020)). Additional membrane materials and structures where the membrane wetting property modification goes deep into the membrane are also of interest. FIG. 12 provides the performance results for a 50-50 PVDF membrane where 50% of the thickness was hydrophobic and the other half was hydrophilic. Other properties of this membrane are listed in Table 5 (below). Tuning of the wetting property change across the membrane thickness may be utilized to enhance the mass transfer rate in MSX for systems having high or low values of the solute distribution/partition coefficient.

TABLE 5
Details of PVDF membrane and the corresponding
50-50 Janus membrane

| | | | LEP (psi)- Water | |
|---|---|---|---|---|
| | Pore Size | Thickness | hydrophilic | hydrophobic |
| Membrane | (μm) | (μm) | side | side |
| PVDF * | 0.1 | 120 | 11 | 14 |
| 50% hydrophobic/ | | | | |
| 50% hydrophilic | | | | |

* MilliporeSigma

FIG. 22 provides an example of the behavior of the overall mass transfer coefficient of a highly solvent-resistant hydrophobic porous polymer membrane of PEEK, one surface of which was hydrophilized. The system could be operated with a higher pressure on either side of the membrane. Additional characterization of other properties of this Janus membrane is provided in Table 6 (below).

TABLE 6
Details of PEEK membrane and the
corresponding Janus membrane

| | | | LEP (psi)- Water | |
|---|---|---|---|---|
| | Pore Size | Thickness | hydrophilic | hydrophobic |
| Membrane | (μm) | (μm) | side | side |
| PEEK 100* | 0.1 | 50 | 45 | 46 |

Janus membranes having hydrophobic and hydrophilic wetting characteristics on two sides of a porous membrane can be used to reduce or eliminate the pressure limitation that plagues nondispersive MSX. Using such a membrane, one can now operate non-dispersively with either phase flowing at a pressure higher than that of the other phase. Porous PVDF and PP membranes were treated on one side either through plasma-polymerization or a KOH/AA treatment, and a Janus membrane with dual wettability was successfully created. The starting PVDF membrane was either hydrophobic or hydrophilic.

A similar strategy was employed with a porous hydrophilic nylon membrane as well. The membranes were used in two different solvent extraction systems in MSX, having widely different solute distribution coefficients. The developed Janus membranes were able to perform on par with the original membrane, while the “wetting” phase for the original membrane was held at a higher pressure over that of the “non-wetting” phase; something that has never been achieved before. It is noted that Janus membranes are novel to MSX because directionality of the pressure gradient across the membrane is no longer crucial; further solvent extraction can take place on both sides of the membrane. In DCMD for example, Janus membranes are only capable of utilizing one side. Therefore, use of Janus membranes in nondispersive MSX is novel.

The porosity of original hydrophilic PVDF-VVPP membranes was estimated by the following method. Four circular samples of 47 mm diameter were individually weighed on a scale. They were then soaked in water for about 2 hr. and then weighed again. These weights were subtracted to calculate the mass of water inside the membrane. Using the known density of water, the volume of water inside the pores of the membrane was calculated. The membrane volume was calculated based on the thickness of the four samples as well as their diameter. The porosity was estimated using Equation 7:

$$ε = \frac{volume of voids in membrane}{volume of membrane} \qquad ( 7 )$$

The porosity values obtained are provided in Table 2 (above).

Water could be analyzed by the GC, but knowing the weight of the diluent (ethanol) added to a known weight of the water/acetone sample allows for calculation of the percentage of acetone in the sample using the GC analysis of the acetone peak of the sample.

The amino functionalities which made one PP membrane surface hydrophilic were confined to only the top atomic layer of the substrate surface and would not show up in the FTIR spectrum shown in FIG. 21. The peaks in the 500 and 800 cm⁻¹ region are likely due to the aromatic=C—H bending and the additional peak in the 1500 cm⁻¹ region is from aromatic C═C stretching.

Hollow Fiber Membranes

In addition to flat Janus membranes, Janus hollow fiber membranes (HFMs) were developed using porous hydrophobic HFMs obtained from Arkema Inc. The properties of the hollow fibers are shown in Table 7 (below).

TABLE 7
Details of PVDF hollow fibers and the module

| Hollow Fiber | Pore | | | | | |
|---|---|---|---|---|---|---|
| Material | size | | OD¹ | ID² | Thickness | No. of |
| (Company) | (μm) | Porosity | (μm) | (μm) | (μm) | Fibers |
| PVDF | 0.2 | 0.54 | 925 | 691 | 117 | 2 |
| (Arkema) | | | | | | |

¹Outside diameter;
²Inner diameter.

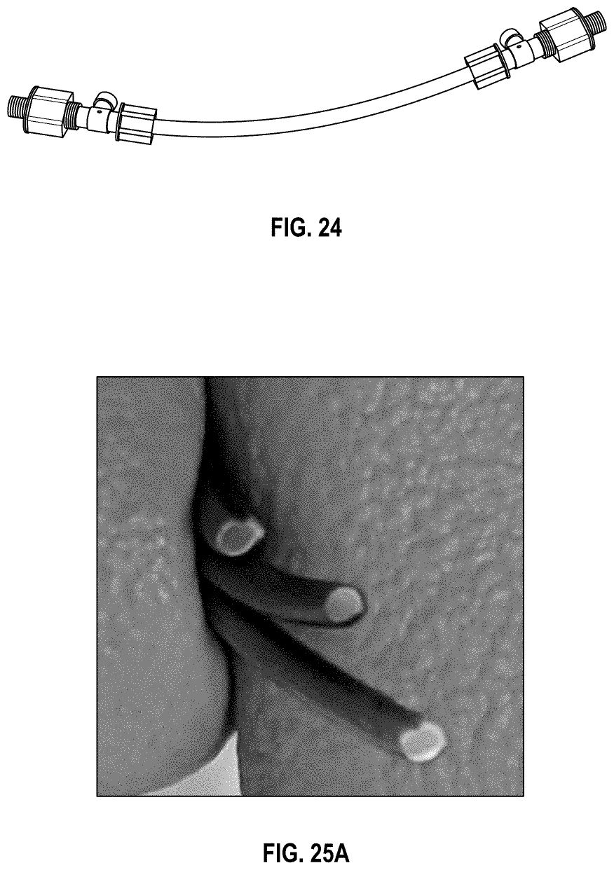

Hydrophobic PVDF hollow fibers from Arkema Inc. were treated in a fashion similar to that for the hydrophobic PVDF-VVHP (MilliporeSigma) flat membranes. The fibers were soaked at 70° C. for 5 days in a beaker with 5 M KOH. The ends of the fibers were carefully taped to the side of the beaker so as not to touch the solution or allow solution inside the fibers. They were then removed, washed with DI water and dried for 2 days. Following this, the fibers were again soaked in an 11.1 wt % acrylic acid (AA) and 0.4 wt % ammonium persulfate (APS) solution for 5 min, placed between glass plates, and placed in the oven for an additional 2 hr at 90° C. Special attention was again given to ensure that the ends of the fibers did not touch the solution and the inside of the fiber was never in contact with the solution. The fibers were subsequently rinsed with DI water and allowed to dry. The PVDF hollow fibers whose outside surface was now hydrophilized were potted in a ¼″ Teflon FEP plastic tubing to create an 8″ long module (FIG. 24). Loctite M-21 HP Epoxy was used to seal the ends of the HFM.

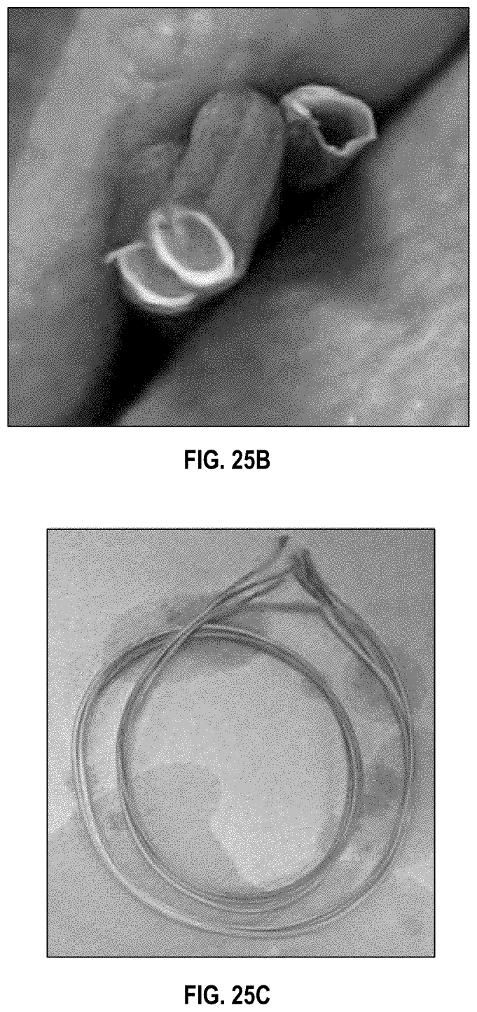

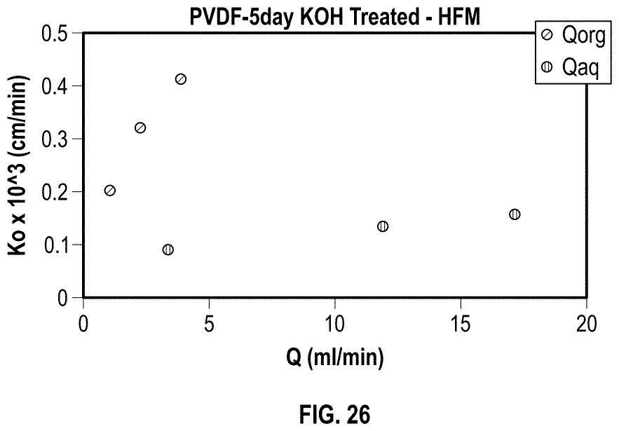

Photos of the Janus PVDF hollow fibers are shown in FIGS. 25A-C. The outside surface of the hollow fibers became hydrophilic with water spreading spontaneously. Membrane solvent extraction experiments were also carried out for this PVDF HFM in which the outside surface of the fibers was treated for 5 days with 5 M KOH and then with an additional AA solution to develop a Janus membrane. FIG. 26 shows the values of Kₒ as Q_{org} and Q_{aq} were varied. The pressure difference between the organic and aqueous phase was about 1 psi. The pressure of the organic phase (the organic phase was the wetting phase of the base hydrophobic membrane) was higher due to the modified hydrophilized outside surface which had water in the pores of the modified section, which allowed the organic phase to have a higher pressure.

Membrane solvent extraction proved to be successful using Janus hollow fiber membranes, with the pressure of the organic phase (the wetting phase of the original-base membrane) greater than that of the aqueous phase. The trends of the flow rate variation were consistent with the trends observed in other studies with hollow fiber membranes. The organic phase flow rate (organic phase flowing through the bore side of the hollow fiber) affected the mass transfer rate significantly more than the aqueous phase flow rate flowing on the shell side for the extraction system studied.

Other virgin hollow fiber surfaces may be modified by a variety of techniques. For example, a surface of a hydrophobic PEEK hollow fiber (outside or inside) may be treated by functionalizing the ketone group on the HFM ID/OD to-OH group via treatment with sodium borohydride (NaBH₄) in isopropyl alcohol at 30-80° C. by reducing the carbonyl group in the benzophenone segment of polymer chains.

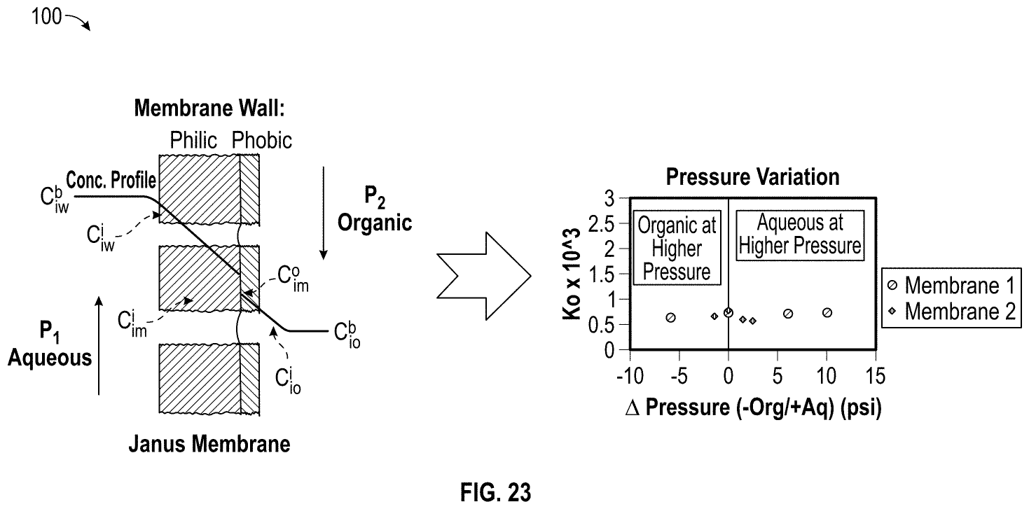

FIG. 23 shows a concentration profile of solute being transferred from one phase to the other in MSX for an exemplary porous composite membrane (similar to FIG. 2), and a graphical depiction showing the effect of phase pressure on overall solute mass transfer coefficient in MSX for octonol/phenol/water system using a hydrophobic PP membrane hydrophilized on one side and a hydrophilic Nylon membrane hydrophobized on one side (similar to FIG. 5).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A porous composite membrane for solvent extraction, the porous composite membrane comprising:
a single membrane comprising a first side and a second side opposing the first side, wherein the first side exhibits hydrophobic characteristics and the second side exhibits hydrophilic characteristics;
wherein at least one of the first side or the second side is sized to perform nondispersive membrane solvent extraction.

2. The porous composite membrane of claim 1, wherein the single membrane is a Janus flat membrane.

3. The porous composite membrane of claim 1, wherein the single membrane is a Janus hollow fiber membrane.

4. The porous composite membrane of claim 1, wherein the first side is uncoated and the second side is coated with a hydrophilic coating.

5. The porous composite membrane of claim 1, wherein the first side is coated with a hydrophobic coating and the second side is uncoated.

6. The porous composite membrane of claim 1, wherein the single membrane includes pores extending through the single membrane from at least one of (i) the first side to the second side, or (ii) the second side to the first side.

7. The porous composite membrane of claim 6, wherein during non-dispersive membrane solvent extraction, the single membrane is configured to receive a first phase along the first side and within the pores of the first side, and a second phase along the second side and the pores of the second side.

8. The porous composite membrane of claim 7, wherein the first phase is an organic phase and the second phase is an aqueous phase.

9. The porous composite membrane of claim 7, wherein a pressure of the first phase within the pores exceeds a pressure of the second phase along the second side without creating phase dispersion through the single membrane.

10. The porous composite membrane of claim 7, wherein even if a breakthrough pressure of the first and second phases is exceeded, phase dispersion through the single membrane is prevented by at least one of the hydrophilic characteristics of the second side or the hydrophobic characteristics of the first side.

11. The porous composite membrane of claim 7, wherein a pressure of the second phase within the pores exceeds a pressure of the first phase along the first side without creating phase dispersion through the single membrane.

12. The porous composite membrane of claim 1, wherein the single membrane is formed from polypropylene (PP), polyvinylidene fluoride (PVDF), polyamide (Nylon) membrane, polyetheretherketone (PEEK), ethylene chlorotrifluoroethylene (ECTFE), or polytetrafluoroethylene (PTFE).

13. A method for nondispersive membrane solvent extraction, comprising:
providing a single membrane including a first side and a second side opposing the first side, wherein the first and second sides have asymmetric wettability;
passing a first phase along the first side of the single membrane; and
passing a second phase along the second side of the single membrane;
wherein at least one of the first side or the second side is sized to perform nondispersive membrane solvent extraction.

14. The method of claim 13, wherein the single membrane is a Janus flat membrane or a Janus hollow fiber membrane.

15. The method of claim 13, wherein the first side exhibits hydrophobic characteristics and the second side exhibits hydrophilic characteristics.

16. The method of claim 13, wherein the single membrane includes pores extending through the single membrane from at least one of (i) the first side to the second side, or (ii) the second side to the first side.

17. The method of claim 16, wherein the membrane is configured to receive the first phase within the pores of the first side of the single membrane, and the second phase along the second side and the pores of the second side.

18. The method of claim 17, wherein the first phase is an organic phase and the second phase is an aqueous phase.

19. The method of claim 18, comprising preventing phase dispersion through the single membrane even if a pressure of the first phase within the pores exceeds a pressure of the second phase along the second side.

20. The method of claim 18, comprising preventing phase dispersion through the single membrane even if a pressure of the second phase within the pores exceeds a pressure of the first phase along the first side.
